(19) United States
(12) Patent Application Publication
(10) Pub. No.: US 2026/0175538 A1
(43) Pub. Date: Jun. 25, 2026

(54) COMPOSITE ARTICLES WITH IMPACT-RESISTANT GLASS-POLYMER LAYERS AND DAMAGE-RESISTANT GLASS LAMINATE LAYERS AND METHODS OF MAKING THE SAME

(71) Applicant: CORNING INCORPORATED, CORNING, NY (US)

(72) Inventors: Petr Gorelchenko, Elmira, NY (US); Manuela Ocampo Davila, Corning, NY (US)

(21) Appl. No.: 19/127,287

(22) PCT Filed: Nov. 15, 2023
(86) PCT No.: PCT/US2023/079762

§ 371 Date: May 5, 2025

Related U.S. Application Data
(60) Provisional application No. 63/428,268, filed on Nov. 28, 2022.

(51) Int. Cl. B32B 17/06; B32B 17/10; C03B 17/06; C03C 3/091; C03C 3/097

(52) U.S. Cl. CPC B32B 17/06; B32B 17/10761; C03B 17/064; C03C 3/091; C03C 3/097

(57) ABSTRACT

An article includes a glass laminate that has a first glass clad layer, a second glass clad layer, and a glass core layer disposed between the first glass clad layer and the second glass clad layer. The first glass clad layer and the second glass clad layer are each fused to the glass core layer. The article further includes a first composite layer attached to the glass laminate via a first polymer layer. The first composite layer includes the first polymer layer and a first glass-based layer attached to the first polymer layer. The first glass-based layer comprises a compressive stress.

### CROSS-REFERENCE TO RELATED APPLICATIONS

This application claims the benefit of priority under 35 U.S.C. § 119 of U.S. Provisional Application No. 63/428,268 filed Nov. 28, 2022, the content of which is incorporated herein by reference in its entirety.

### FIELD

The present disclosure relates to composite glass-based articles and, more particularly, to composite glass-based articles comprising glass-polymer layers and glass laminate layers arranged relative to one another and methods for forming the same.

### BACKGROUND

Light detection and ranging (“LiDAR”) systems comprise a laser and a sensor. The laser emits a laser beam, which may reflect off an object, and the sensor detects the reflected laser beam. The laser beams are pulsed or otherwise distributed across a radial range to detect objects across a field of view. Information about the object can be deciphered from the properties of the detected reflected laser beam. Distance of the object from the laser beam can be determined from the time of flight from emission of the laser beam to detection of the reflected laser beam. If the object is moving, path and velocity of the object can be determined from shifts in radial position of the emitted laser beam being reflected and detected as a function of time, as well as from Doppler frequency measurements.

Vehicles are a potential application for LiDAR systems, with the LiDAR systems providing spatial mapping capability to enable assisted, semi-autonomous, or fully autonomous driving. Conventionally, the laser emitter and sensor are mounted on the roof of the vehicle or on a low forward portion of the vehicle. Lasers emitting electromagnetic radiation having a wavelength outside the range of visible light, such as at or near 905 nm or 1550 nm are considered for vehicle LiDAR applications. To protect the laser and sensor from impact from rocks and other objects, a window is placed between the laser and sensor, and the external environment in the line of sight of the laser and sensor. However, there is a problem in that impacting rocks and other objects scratch and cause other types of damage to the window, which cause the window to scatter the emitted and reflected laser beams, thus impairing the effectiveness of the LiDAR system. In particular, sharp contact/impact may create damage that propagates through the thickness of the window and then creates radial/median cracks therein. To optimize impact resistance, especially for a thin composite to be used as the window, it would be desirable to address this mechanism of crack formation.

### SUMMARY

According to aspect (1), an article is provided. The article comprise: a glass laminate comprising a first glass clad layer, a second glass clad layer, and a glass core layer disposed between the first glass clad layer and the second glass clad layer, each of the first glass clad layer and the second glass clad layer fused to the glass core layer; and a first composite layer attached to the glass laminate via a first polymer layer, the first composite layer comprising the first polymer layer and a first glass-based layer attached to the first polymer layer, the first glass-based layer comprising a compressive stress.

According to aspect (2), the article of aspect (1) is provided, wherein the glass laminate has a thickness T_{GL}, the first glass-based layer has a thickness t_{G1}, and the first polymer layer has a thickness t_{P1}, and wherein t_{P1}<t_{G1}<t_{GL}.

According to aspect (3), the article of aspect (2) is provided, wherein t_{P1}≤10 μm.

According to aspect (4), the article of aspect (2) is provided, wherein t_{P1}≤2 μm.

According to aspect (5), the article of any one of aspects (2)-(4) is provided, wherein t_{G1}<300 μm.

According to aspect (6), the article of any one of aspects (2)-(4) is provided, wherein t_{G1}≤150 μm.

According to aspect (7), the article of any one of aspects (2)-(6) is provided, wherein t_{GL}≥1.0 mm.

According to aspect (8), the article of any one of aspects (2)-(6) is provided, wherein t_{GL}≥1.5 mm.

According to aspect (9), the article of any one of aspects (2)-(8) is provided, wherein t_{GL}≤3.8 mm.

According to aspect (10), the article of any one of the preceding aspects is provided, wherein: the glass laminate has an effective coefficient of thermal expansion CTE_{GL}, the first glass-based layer has a coefficient of thermal expansion CTE_{G1}, the first polymer layer has a coefficient of thermal expansion CTE_{P1}, and the compressive stress in the first glass-based layer comprises one or more additive portions of the compressive stress that arises from one or more relationships comprising two or more of CTE_{GL}, CTE_{G1}, and CTE_{P1}.

According to aspect (11), the article of aspect (10) is provided, wherein a first additive portion of the compressive stress arises from a relationship among CTE_{GL}, CTE_{G1}, and CTE_{P1}.

According to aspect (12), the article of aspect (11) is provided, wherein the relationship comprises CTE_{P1}−(CTE_{G1}+CTE_{GL})/2>1 ppm/° C.

According to aspect (13), the article of any one of aspects (10)-(12) is provided, wherein a second additive portion of the compressive stress arises from a differential between CTE_{GL} and CTE_{G1}.

According to aspect (14), the article of aspect (13) is provided, wherein ICTE_{GL}−CTE_{G1}|≥0.4 ppm/C.

According to aspect (15), the article of any one of aspects (10)-(14) is provided, wherein the one or more additive portions of the compressive stress arises from laminating the first glass-based layer to the glass laminate via the first polymer layer at a curing temperature that differs from a usage temperature of the article by at least 10° C.

According to aspect (16), the article of any one of the preceding aspects is provided, wherein the compressive stress in the first glass-based layer is in a range from about 5 MPa to about 100 MPa.

According to aspect (17), the article of any one of the preceding aspects is provided, wherein the first polymer layer has a glass transition temperature of greater than or equal to 20° C.

According to aspect (18), the article of any one of the preceding aspects is provided, wherein the first polymer layer has a storage modulus of greater than or equal to 5 MPa and less than or equal to 20,000 MPa at temperatures between 0° C. and 40° C.

According to aspect (19), the article of any one of the preceding aspects is provided, wherein the glass core layer has a coefficient of thermal expansion CTE_{core}, and wherein the first glass clad layer and the second glass clad layer each have a coefficient of thermal expansion CTE_{clad} that is less than the CTE_{core}.

According to aspect (20), the article of any one of the preceding aspects is provided, wherein a maximum tensile stress in the glass core layer is less than about 10 MPa.

According to aspect (21), the article of any one of the preceding aspects is provided, wherein the first glass clad layer and the second glass clad layer each have a clad compressive stress.

According to aspect (22), the article of aspect (21) is provided, wherein the clad compressive stress extends from a surface of the first clad layer and the second glass clad layer, respectively, to a depth of compression of greater than or equal to 10% of a thickness of the glass laminate tGL.

According to aspect (23), the article of any one of the preceding aspects is provided, wherein the first glass-based layer comprises an anomalous glass that exhibits an anomalous fracture behavior when subjected to a Vickers diamond indenter test.

According to aspect (24), the article of any one of the preceding aspects is provided, wherein the first glass-based layer comprises a borosilicate glass.

According to aspect (25), the article of any one of the preceding aspects is provided, wherein the first glass clad layer and the second glass clad layer each comprise a clad glass composition comprising boron.

According to aspect (26), the article of aspect (25) is provided, wherein the clad glass composition comprises greater than 10 wt. % B₂O₃ and less than or equal to 50 wt. % B₂O₃.

According to aspect (27), the article of any one of the preceding aspects is provided, wherein the core glass layer comprises a core glass composition comprising less than or equal to 20 wt. % B₂O₃.

According to aspect (28), the article of any one of the preceding aspects is provided, further comprising a second composite layer attached via a second polymer layer to the glass laminate or the first composite layer, the second composite layer comprising the second polymer layer and a second glass-based layer attached to the second polymer layer, wherein the second glass-based layer has a thickness t_{G2} and a coefficient of thermal expansion CTE_{G2}, and wherein the second polymer layer has a thickness t_{P2} and a coefficient of thermal expansion CTE_{P2}.

According to aspect (29), the article of aspect (28) is provided, wherein the second composite layer is attached to the glass laminate.

According to aspect (30), the article of aspect (28) is provided, wherein the second composite layer is attached to the first composite layer.

According to aspect (31), the article of any one of aspects (28)-(30) is provided, wherein the first glass-based layer and the second glass-based layer have the same composition such that CTE_{G2}=CTE_{G1}.

According to aspect (32), the article of any one of aspects (28)-(30) is provided, wherein the first polymer layer and the second polymer layer have the same composition such that CTE_{P2}=CTE_{P1}.

According to aspect (33), the article of any one of aspects (28)-(32) is provided, wherein the second glass-based layer has a thickness t_{G2} that equals t_{G1}, and wherein the second polymer layer has a thickness t_{P2} that equals t_{P1}.

According to aspect (34), the article of any one of the preceding aspects is provided, wherein a total thickness of the article is less than or equal to 4.5 mm.

According to aspect (35), a sensor is provided. The sensor comprises: an enclosure; a detection element disposed in the enclosure; and a window attached to the enclosure to enclose an interior of the enclosure, the window comprising the article of the first aspect.

According to aspect (36), a method is provided. The method comprises: disposing a first polymer layer between a first glass-based layer and a glass laminate, the glass laminate comprising a first glass clad layer, a second glass clad layer, and a glass core layer disposed therebetween and fused to the first glass clad layer and the second glass clad layer; heating the first polymer layer, the first glass-based layer, and the glass laminate to a curing temperature TC; curing the first polymer layer at the curing temperature TC to form an article; and after the curing, returning the article to a usage temperature TU that differs from the curing temperature TC by at least 10° C. the first glass-based layer comprising a compressive stress at the usage temperature.

According to aspect (37), the method of aspect (36) is provided, wherein: the glass laminate has an effective coefficient of thermal expansion CTE_{GL}, the first glass-based layer has a coefficient of thermal expansion CTE_{G1}, the first polymer layer has a coefficient of thermal expansion CTE_{P1}, and the compressive stress in the first glass-based layer comprises one or more additive portions of the compressive stress that arises from one or more relationships comprising two or more of CTE_{GL}, CTE_{G1}, and CTE_{P1}.

According to aspect (38), the method of aspect (37) is provided, wherein a first additive portion of the compressive stress arises from a relationship in which CTE_{P1}−(CTE_{G1}+CTE_{GL})/2>1 ppm/° C.

According to aspect (39), the method of aspect (37) or aspect (38) is provided, wherein a second additive portion of the compressive stress arises from a relationship in which |CTE_{GL}−CTE_{G1}|>0.4 ppm/° C.

According to aspect (40), the method of any one of aspects (37)-(39) is provided, wherein T_{C}<T_{U} and CTE_{G1}>CTE_{GL}.

According to aspect (41), the method of any one of aspects (37)-(39) is provided, wherein T_{C}>T_{U} and CTE_{GL}>CTE_{G1}.

According to aspect (42), the method of aspect (41) is provided, wherein the first polymer layer has a glass transition temperature Tg_{P1}, and wherein T_{C}>Tg_{P1}+10° C.

According to aspect (43), the method of any one of aspects (36)-(42) is provided, wherein the curing comprises one or more of irradiating the first polymer layer with ultraviolet light and heat treating the first polymer layer.

### BRIEF DESCRIPTION OF THE DRAWINGS

FIG. 1 is a schematic cross-sectional view of a glass-based article comprising two glass-polymer composite layers attached to opposite sides of a glass laminate according to embodiments;

FIG. 2 is a schematic cross-sectional view of a glass-based article comprising one glass-polymer composite layer attached to one side a glass laminate according to embodiments; and

FIG. 3 is a schematic cross-sectional view of a glass-based article comprising two glass-polymer composite layers disposed on the same side of a glass laminate according to embodiments;

FIG. 4 schematically depicts an apparatus for forming the glass laminate of FIGS. 1-3 according to embodiments;

FIG. 5 is a side view of a vehicle having a LiDAR system mounted on a roof of the vehicle and a LiDAR system mounted on a forward portion of the vehicle according to embodiments:

FIG. 6 is a conceptual view of one of the LiDAR systems of FIG. 5, comprising a cover window into which one or more of the glass-based articles of the present disclosure can be incorporated;

FIG. 7 is a digital image showing results of sharp impact testing performed on Comparative Example 1;

FIG. 8 is a digital image showing results of sharp impact testing performed on Comparative Example 2;

FIG. 9 is a digital image showing results of sharp impact testing performed on Comparative Example 3;

FIG. 10A and FIG. 10B show microscopic views of a top surface (FIG. 10A) and a back surface (FIG. 10B) of one sharp impact event on Comparative Example 3 from the results shown in FIG. 9;

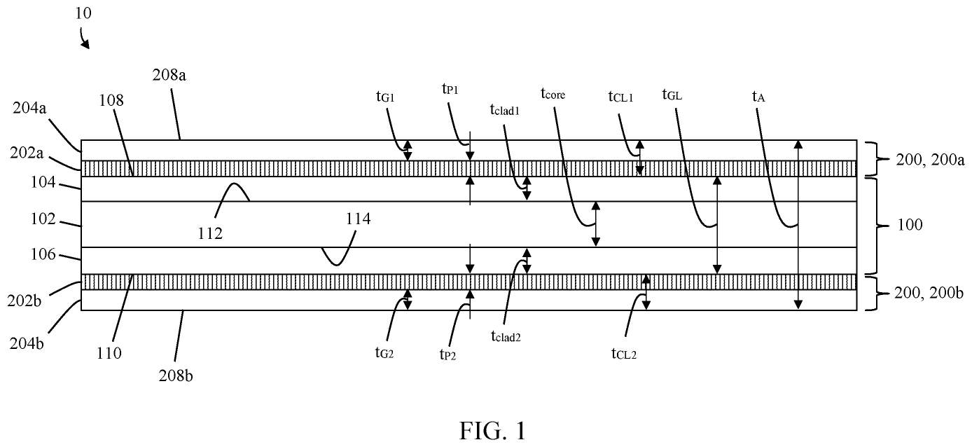

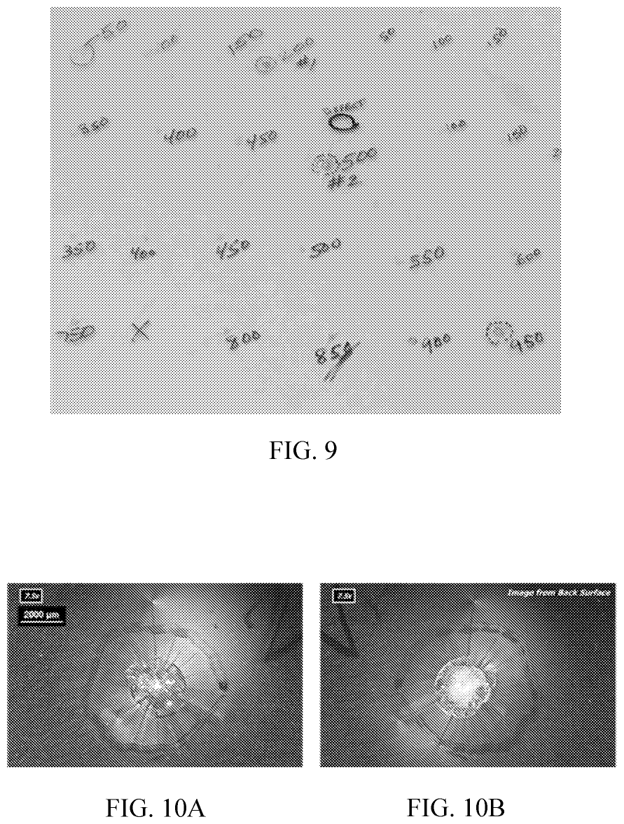

FIG. 1I shows a microscopic view of one sharp impact event on Comparative Example 3 from the results shown in FIG. 9 to illustrate delayed growth of cracks over time; and

FIG. 12 is a digital image showing results of sharp impact testing performed on Example 1.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination: A and C in combination: B and C in combination: or A, B, and C in combination.

In this document, relational terms, such as first and second, top and bottom, and the like, are used solely to distinguish one entity or action from another entity or action, without necessarily requiring or implying any actual such relationship or order between such entities or actions.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial.” “substantially.” and variations thereof as used herein, unless defined elsewhere in association with specific terms or phrases, are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein—for example up, down, right, left, front, back, top, bottom, above, below, and the like—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the term “average coefficient of thermal expansion,” or “average CTE,” refers to the average coefficient of linear thermal expansion of a given material or layer between 0° C. and 300° C. As used herein, the term “coefficient of thermal expansion,” or “CTE,” refers to the average coefficient of thermal expansion unless otherwise indicated.

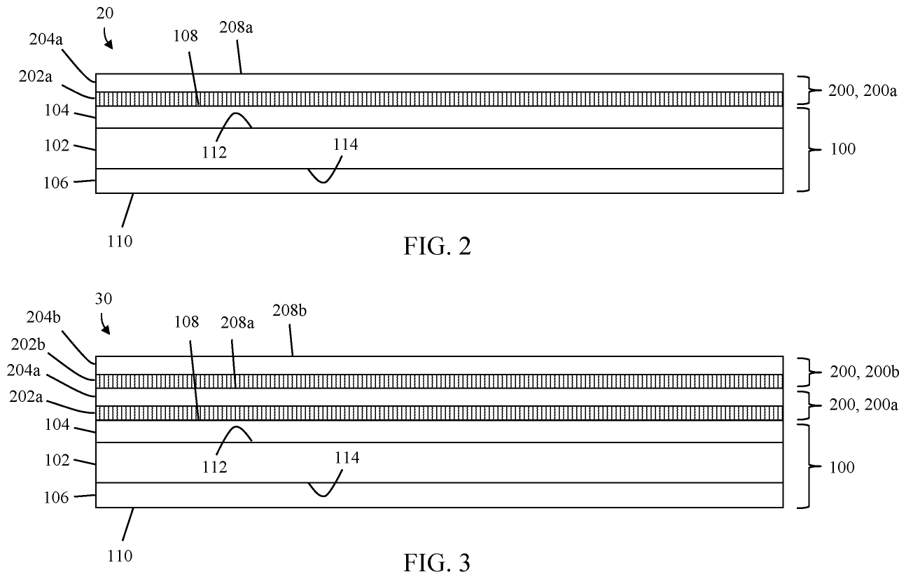

FIG. 1 is a schematic cross-sectional view of an exemplary glass-based article 10 according to embodiments. The glass-based article 10 includes a glass laminate 100 disposed between two glass-polymer composite layers 200. The glass laminate 100 is a laminated sheet including a plurality of glass layers. In embodiments, the laminated sheet can be substantially planar, as shown in FIG. 1, or the laminated sheet can be non-planar. The glass laminate 100 comprises a glass core layer 102 disposed between a first glass clad layer 104 and a second glass clad layer 106. As shown in FIG. 1, the first glass clad layer 104 and/or the second glass clad layer 106 are intermediate layers disposed between the glass core layer 102 and one or more exterior layers (e.g., the glass-polymer composite layers 200). In embodiments, the first clad layer 104 and/or the second glass clad layer 106 can be exterior layers relative to the glass core layer 102. For example, an outer surface 108 of the first glass clad layer 104 can be an outer surface of the glass laminate 100 (not shown) and/or an outer surface 110 of the second glass clad layer 106 can be an outer surface of the glass laminate 100, such as described later with reference to FIG. 2 and FIG. 3.

The glass core layer 102 comprises a first major surface and a second major surface opposite the first major surface. In embodiments, the first glass clad layer 104 is fused to the first major surface of the glass core layer 102, and the second glass clad layer 106 is fused to the second major surface of the glass core layer 102. In such embodiments, an interface 112 between the first glass clad layer 104 and the glass core layer 102 and/or an interface 114 between the second glass clad layer 106 and the glass core layer 102 are free of any bonding material such as, for example, an adhesive, a coating layer, or any non-glass material added or configured to adhere the respective glass clad layers to the glass core layer. Thus, the first glass clad layer 104 and/or the second glass clad layer 106 are fused directly to the glass core layer 102 and/or are directly adjacent to the glass core layer 102. In embodiments, the glass laminate 100 includes one or more intermediate layers disposed between the glass core layer and the first glass clad layer and/or between the glass core layer and the second glass clad layer. For example, the intermediate layers can comprise intermediate glass layers and/or diffusion layers formed at the interface of the glass core layer and the glass clad layer. The diffusion layer can comprise a blended region comprising components of each layer adjacent to the diffusion layer (e.g., a blended region between two directly adjacent glass layers). In embodiments, the glass laminate 100 comprises a glass-glass laminate in which the interfaces between directly adjacent glass layers are glass-glass interfaces.

In an exemplary embodiment, as shown in FIG. 1, the two glass-polymer composite layers 200 are disposed on opposite sides of the glass laminate 100. The two glass-polymer composite layers 200 can comprise a first glass-polymer composite layer 200a (hereinafter “first composite layer”) disposed on a first side of the glass laminate 100 and a second glass-polymer composite layer 200b (hereinafter “second composite layer”) disposed on a second side of the glass laminate 100 opposite the first side. The first composite layer 200a comprises a first polymer layer 202a and a first glass-based layer 204a attached to the first polymer layer 202a. The first composite layer 200a is attached to the glass laminate 100 via the first polymer layer 202a. In particular, the first polymer layer 202a is attached to the outer surface 108 of the first glass clad layer 104. The second composite layer 200b comprises a second polymer layer 202b and a second glass-based layer 204b attached to the second polymer layer 202b. The second composite layer 200b is attached to the glass laminate 100 via the second polymer layer 202b. In particular, the second polymer layer 202b is attached to the outer surface 110 of the second glass clad layer 106. In embodiments, the first glass-based layer 204a and/or the second glass-based layer 204b are exterior layers relative to the glass-based article 10. For example, an outer surface 208a of the first glass-based layer 204a can be an outer surface of the glass-based article 10 and/or an outer surface 208b of the second glass-based layer 204b can be an outer surface of the glass-based article 10.

In embodiments, the glass-based article can comprise different numbers of the glass-based layers, different numbers of the glass-polymer composite layers, and/or different arrangements of the glass-polymer composite layers. For example, as shown in FIG. 2, the glass-based article 20 includes one glass-polymer layer (e.g., the first composite layer 200a) attached to one side of the glass laminate 100. The first composite layer 200a is attached to the glass laminate 100 via the first polymer layer 202a. In particular, the first polymer layer 202a is attached to the outer surface 108 of the first glass clad layer 104. The outer surface 208a of the first glass-based layer 204a of the first composite layer 200a is an outer or exterior surface on one side of the glass-based article 20. The outer surface 110 of the second glass clad layer 106 is an outer or exterior surface on the opposite side of the glass-based article 20 due to the number of the glass-polymer composite layers (e.g., one).

As shown in FIG. 3, the glass-based article 30 includes two glass-polymer composite layers (e.g., the first composite layer 200a and the second composite layer 200b) disposed on one side (e.g., the same side) of the glass laminate 100. The first composite layer 200a is attached to the glass laminate 100 via the first polymer layer 202a. In particular, the first polymer layer 202a is attached to the outer surface 108 of the first glass clad layer 104. The second composite layer 200b is attached to the first composite layer 200a via the second polymer layer 202b. In particular, the second polymer layer 202b is attached to the outer surface 208a of the first glass-based layer 204a. The outer surface 208b of the second glass-based layer 204b of the second composite layer 200b is an outer or exterior surface on one side of the glass-based article 30. The outer surface 110 of the second glass clad layer 106 is an outer or exterior surface on the opposite side of the glass-based article 30 due to the number of the glass-polymer composite layers (e.g., two) and the arrangement of the glass-polymer composite layers (e.g., on the same side of the glass laminate 100).

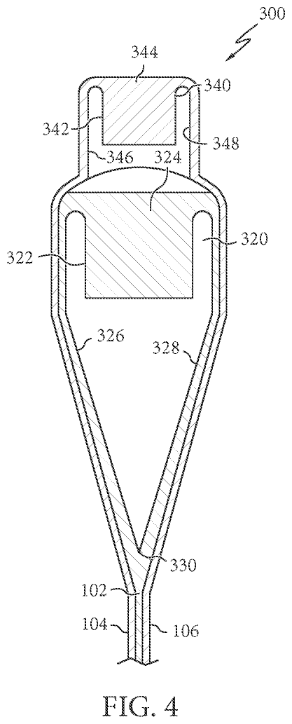

While the glass-based article 10 of FIG. 1 and the glass-based article 30 of FIG. 3 each include five glass-based layers (e.g., the three glass-based layers 102, 104, 106 of the glass laminate 100 and the two glass-based layers 204a, 204b of the two glass-polymer composite layers 200a, 200b), the glass-based articles described herein can include greater or lesser numbers of glass-based layers. For example, the glass-based article can include four glass-based layers (e.g., the article 20 of FIG. 4), six glass-based layers, or seven glass-based layers in embodiments. While the glass-based article 10 of FIG. 1 and the glass-based article 30 of FIG. 3 each include two polymer layers (e.g., the two polymer layers 202a, 202b of the two glass-polymer composite layers 200a, 200b), the glass-based articles described herein can include greater or lesser numbers of polymer layers. For example, the glass-based article can include one polymer layer (e.g., the article 20 of FIG. 4), three polymer layers, or four polymer layers in embodiments. As shown in FIGS. 1-3, the outer planar surfaces of the glass-based articles can be formed by a glass-based layer. For this reason, at least some of the properties of the glass-based article, can be attributable and substantially similar to the properties of the outer/exterior/exposed glass-based layer.

Referring again to FIG. 1, the glass laminate 100 has a (total) thickness t_{GL}, that includes a thickness t_{core} of the glass core layer 102, a thickness t_{clad1} of the first glass clad layer 104, and a thickness t_{clad2} of the second glass clad layer 106, such that T_{GL}=t_{core}+t_{clad1}+t_{clad2}. In embodiments, the first and second glass clad layers 104, 106 can have the same thickness t_{clad}, such that t_{GL}=t_{core}+2t_{clad}. The first glass-based layer 204a has a thickness t_{G1} and the first polymer layer 202a has a thickness tri. The first composite layer 200a has a (total) thickness t_{CL1} that includes the thickness t_{G1} of the first glass-based layer 204a and the thickness t_{P1} of the first polymer layer 202a, such that t_{CL1}=t_{G1}+T_{P1}. In embodiments that include the second composite layer 200b, the second glass-based layer 204b has a thickness t_{G2} and the second polymer layer 202b has a thickness t_{P2}. The second composite layer 200b has a (total) thickness t_{CL2} that includes the thickness t_{G2} of the second glass-based layer 204b and the thickness t_{P2} of the second polymer layer 202b, such that t_{CL2}=t_{G2}+t_{P2}. In embodiments that include the second composite layer 200b, the glass-based article can include one or more of the following relationships: T_{CL1}=T_{CL2}, T_{CL1}≠T_{CL2}, T_{G1}=T_{G2}, T_{G1}≠T_{G2}, T_{P1}=T_{P2}, and T_{P1}≠T_{P2}. The glass-based article has a (total) thickness t_{A} that includes the thickness t_{GL} of the glass laminate 100 and the thickness t_{CL1} of the first composite layer 200a, such that t_{A}=t_{GL}+t_{CL1}. In embodiments that include the second composite layer 200b, t_{A}=t_{GL}+t_{CL1}+t_{CL2}.

The first glass-based layer 204a is configured to comprise a compressive stress. In embodiments in which the glass-based article comprises two glass-polymer composite layers 200a, 200b on the same side, the outermost layer (i.e., the second glass-based layer 204b) comprises the compressive stress. In embodiments, the compressive stress of the first glass-based layer 204a arises due to mechanical strengthening, for example, the arrangement of glass-based layers and the polymer layers with different coefficients of thermal expansion (CTEs) that result in the desired compressive stress. The glass laminate 100 has an effective coefficient of thermal expansion CTE_{GL}, the first glass-based layer 204a has a coefficient of thermal expansion CTE_{G1}, and the first polymer layer 202a has a coefficient of thermal expansion CTE_{P1}. In embodiments, the compressive stress in the first glass-based layer 204a comprises one or more additive portions of the compressive stress that arises from one or more relationships comprising two or more of CTE_{GL}, CTE_{G1}, and CTE_{P1}. As used herein, an “additive portion” of the compressive stress means that a specified CTE relationship contributes to a distinct portion of the (total) compressive stress in the specified layer (e.g., the first glass-based layer 204a). For example, a first additive portion of the compressive stress may arise from a first CTE relationship, a second additive portion of the compressive stress may arise from a second CTE relationship, and so on. The (total) compressive stress in the specified layer includes a sum of the first additive portion, the second additive portion, and any further additive portions.

In embodiments, the glass laminate 100 is mechanically strengthened. For example, the glass laminate 100 can be configured such that at least one of the first and second glass clad layers 104, 106 and the glass core layer 102 have different coefficients of thermal expansion (CTE), though in other embodiments such CTE mismatch can be substantially zero or zero. In embodiments, at least one of the first and second glass clad layers 104, 106 is formed from a glass clad composition and has an average clad coefficient of thermal expansion CTE_{clad} that is less than an average core coefficient of thermal expansion CTE_{core} of a glass core composition that forms the glass core layer 102. Suitable glass compositions used to form the glass core layer and the glass clad layers of the glass laminate 100 are described later in this disclosure.

The CTE mismatch (i.e., the difference between the CTE_{clad} of the first and second glass clad layers 104, 106 and the CTE_{core} of the glass core layer 102) results in the formation of compressive stress in the glass clad layers and tensile stress in the glass core layer upon cooling of the glass laminate 100. Surface compressive stresses tend to suppress existing surface flaws from developing into cracks. Higher CTE mismatch results in higher surface compression in the glass clad layer. Additionally, a thicker glass clad layer results in a deeper depth of compression (DOC). However, such higher surface compressive stress and deeper DOC also result in increasing tensile stress in the core layer. Accordingly, the various factors should be balanced with one another as described herein.

In embodiments, the residual stress in each of the glass-based layers of the glass laminate 100 can be calculated according to the following equations:

$${σ}_{clad} = \frac{{E}_{clad}}{( 1 - {v}_{clad} ) + \frac{{E}_{clad} ( 1 - {v}_{core} )}{{E}_{core} R}} ( {α}_{core} - {α}_{clad} ) ( {T}_{lamination} - {T}_{room} ) ;$$

$${σ}_{core} = \frac{{E}_{core}}{( 1 - {v}_{core} ) + \frac{{E}_{core} R ( 1 - {v}_{clad} )}{{E}_{clad}}} ( {α}_{core} - {α}_{clad} ) ( {T}_{lamination} - {T}_{room} ) ;$$

$$R = \frac{{t}_{core}}{2 {t}_{clad}} = - \frac{{σ}_{clad}}{{σ}_{core}}$$

where σ is the stress, α is the CTE, E is the Young's modulus, v is Poisson's ratio, t is the layer thickness, R is the total core/clad thickness ratio, and T is the temperature. The lamination temperature (Tₗₐₘᵢₙₐₜᵢₒₙ) is the strain point of the clad or the core, minus 5 degrees, whichever is lower.

The effective CTE_{GL} of the glass laminate 100 can be calculated according to the following equation:

$${α}_{eff} = \frac{\frac{2 {t}_{clad} {E}_{clad}}{1 - {v}_{clad}} {α}_{clad} + \frac{{t}_{core} {E}_{core}}{1 - {v}_{core}} {α}_{core}}{\frac{2 {t}_{clad} {E}_{clad}}{1 - {v}_{clad}} + \frac{{t}_{core} {E}_{core}}{1 - {v}_{core}}} = \frac{\frac{{E}_{clad}}{1 - {v}_{clad}} {α}_{clad} + \frac{{RE}_{core}}{1 - {v}_{core}} {α}_{core}}{\frac{{E}_{clad}}{1 - {v}_{clad}} + \frac{{RE}_{core}}{1 - {v}_{core}}}$$

where α is the CTE, E is Young's modulus, v is Poisson's ratio, t is the thickness of the layer, and R is the total core/clad thickness ratio.

In embodiments in which the Young's modulus and the Poisson's ratio of the glass clad layer and the glass core layer are close (e.g., when the values of E/(1-v) for the glass core layer and the glass cladding layer are within 5%), the equation can be simplified as the following equation:

$${α}_{eff} \approx \frac{{α}_{clad} + R {α}_{core}}{( 1 + R )} = ( 1 - β ) {α}_{clad} + {βα}_{core}$$

where β is the core and total thickness ratio, or the core percentage.

In embodiments, the CTE differential between the glass core layer 102 and the glass clad layers 104, 106 (i.e., |CTE_{core}−CTE_{clad}|) of the glass laminate 100 is sufficient to generate a surface compressive stress in the clad layers. In embodiments, the CTE differential between the glass core layer 102 and the glass clad layers 104, 106 is sufficient to create a compressive stress in the glass clad layers 104, 106 of greater than or equal to 10 MPa and less than or equal to 200 MPa which extends from a surface of the glass clad layer 104, 106 and through the thickness of the glass clad layers 104, 106 to the interface 112, 114 between the glass clad layers 104, 106 and the glass core layer 102. That is, the compressive stress due to the CTE differential between the glass core layer 102 and the glass clad layers 104, 106 is greater than or equal to 10 MPa and less than or equal to 200 MPa. In embodiments, the glass clad layer has a maximum compressive stress that is less than 200 MPa, less than 180 MPa, less than 150 MPa, less than 100 MPa, less than 75 MPa, less than 50 MPa, less than 40 MPa, less than 30 MPa, or less than 25 MPa, less than 20 MPa, or less than 15 MPa. In embodiments, the compressive stress is constant from the surface of the glass clad layer to the interface 112, 114 between the glass clad layer and the glass core layer, although other stress profiles are contemplated.

In the case of impacts with relatively high impact energy, a resulting flaw or defect may penetrate through the glass-polymer composite layer 200a. 200b and into the glass laminate 100. The high surface compression can help to prevent flaws from propagating within the depth of the glass laminate 100. Additionally, the continued high compression level meets the flaw through a greater depth of the glass laminate 100 described herein, helping to arrest the propagation of the flaw. Thus, the increased compression can provide improved resistance to flaw propagation.

If a flaw does propagate beyond the buried surface of the glass laminate 100, the compressive stress extending relatively deep into the glass laminate 100 (e.g., a deep depth of compression, or DOC) can help to prevent failure of the glass-based article as a result of the flaw (e.g., by preventing the flaw from reaching the core layer that is in tension). Thus, the presence of the increased compression through a greater depth of the glass laminate 100 (e.g., provided by mechanical strengthening) can provide improved resistance to failure compared to a glass laminate having a rapidly decreasing compressive stress deeper into the glass laminate.

In embodiments, the compressive stress due to the CTE differential between the glass core layer 102 and the glass clad layers 104, 106 extends from a surface of the glass clad layer to a DOC that is greater than or equal to 10% of the total thickness t_{GL} of the glass laminate 100. Moreover, in embodiments, the thickness t_{clad} of the clad layer can be adjusted to provide for a varying DOC as well as improved retained strength for flaws of various ranges. Accordingly, the retained strength can be adjusted by adjusting the DOC to address flaws of various sizes.

For example, in embodiments, the depth of compression is greater than or equal to 12%, greater than or equal to 15%, greater than or equal to 20%, greater than or equal to 25%, greater than or equal to 30%, or greater than or equal to 35% of the total thickness t_{GL} of the glass laminate 100. In embodiments, the depth of compression is less than or equal to 40%, less than or equal to 35%, less than or equal to 30%, less than or equal to 25%, less than or equal to 20%, less than or equal to 15%, or less than or equal to 12% of the total thickness t_{GL} of the glass laminate 100.

In embodiments, the CTE differential between the glass core layer 102 and the glass clad layers 104, 106 (i.e., |CTE_{core}−CTE_{clad}|) is sufficient to generate a tensile stress in the glass core layer 102, also known as a core tension or central tension. In embodiments, the CTE differential between the glass core layer 102 and the glass clad layers 104, 106 is sufficient to create a tensile stress in the glass core layer 102 of greater than or equal to 1 MPa and less than or equal to 20 MPa which extends through the thickness of the glass core layer 102. That is, the tensile stress due to the CTE differential between the glass core layer 102 and the glass clad layers 104, 106 is greater than or equal to 1 MPa and less than or equal to 20 MPa.

In conventional glass laminates, the glass core layer may have a maximum tensile stress of greater than 20 MPa, to provide a large CTE differential and achieve a high compressive stress on the clad layers 104, 106. However, a glass core layer 102 with a maximum tensile stress of less than 20 MPa, as disclosed herein, may exhibit reduced crack propagation within the core layer 102 as compared to a conventional core layer with a maximum tensile stress of greater than 20 MPa. Without being bound by theory, if the maximum tensile stress of a core layer 102 is greater than 9 MPa, a crack that occurs within the core layer 102 may propagate throughout the core layer 102, whereas a core layer 102 with a maximum tensile stress of less than 9 MPa may prevent crack propagation. In embodiments, the glass core layer has a maximum tensile stress that is less than 20 MPa, less than 15 MPa, less than 12 MPa, less than 10 MPa, less than 9 MPa, less than 8 MPa, less than 7 MPa, less than 6 MPa, or less than 5 MPa.

The glass compositions used to form the glass core layer and the glass clad layers of the glass laminate 100 may include several suitable glass compositions. For example, the glass compositions may generally include a combination of SiO₂, Al₂O₃, at least one alkaline earth oxides such as BeO, MgO, CaO, SrO and BaO, and/or alkali oxides, such as Li₂O, Na₂O, K₂O, Rb₂O and Cs₂O. In embodiments, the glass compositions are alkali-free, while in other embodiments, the glass compositions include one or more alkali oxides. In embodiments, the glass compositions may further include minor amounts of one or more additional oxides, such as, by way of example and not limitation, SnO₂, Sb₂O₃, ZrO₂, ZnO, or the like. These components may be added as fining agents and/or to further modify the CTE of the glass composition.

In embodiments, the glass compositions used to form the glass core layer and the glass clad layers can include SiO₂ in an amount from greater than or equal to about 35 wt. % to less than or equal to about 80 wt. %, Al₂O₃ in an amount from greater than or equal to about 1.5 wt. % to less than or equal to about 25 wt. %, B₂O₃ in amounts discussed below, P₂O₅ in an amount from greater than or equal to about 1.5 wt. % to less than or equal to 25 wt. %, one or more alkali oxides (e.g., Na₂O, K₂O, Li₂O, or the like) in an amount from greater than or equal to 6 wt. % to less than or equal to 40 wt. %, and one or more alkaline earth oxides (e.g., MgO. CaO, SrO, BaO, or combinations thereof) in an amount from greater than or equal to 1 wt. % to less than or equal to 22 wt. %. The clad glass composition can further include B₂O₃ in an amount from greater than or equal to 10 wt. % to less than or equal to 50 wt. % B₂O₃. In comparison, in embodiments, the core glass composition can further include B₂O₃ in an amount from greater than or equal to 0 wt. % to less than or equal to 20 wt. %. The glass compositions used to form the glass core layer and the glass clad layers of the glass laminate 100 can include the glass compositions disclosed in U.S. Patent Application Publication No. 2022/0161518 A1, published on May 26, 2022, which is incorporated herein by reference in its entirety.

In embodiments, the glass compositions used to form the glass core layer and the glass clad layers of the glass laminate 100 have a liquidus viscosity suitable for forming the glass laminate 100 using a fusion draw process as described herein. For example, each of the glass compositions may have a liquidus viscosity of at least about 100 kP, at least about 200 kP, or at least about 300 kP. Additionally, or alternatively, the core glass composition comprises a liquidus viscosity of less than about 3000 kP, less than about 2500 kP, less than about 1000 kP, or less than about 800 kP. The clad glass composition of the clad layers 104 and 106 may have a liquidus viscosity of at least about 50 kP, at least about 100 kP, or at least about 200 kP. Additionally, or alternatively, the clad glass composition comprises a liquidus viscosity of less than about 3000 kP, less than about 2500 kP, less than about 1000 kP, or less than about 800 kP. The core glass composition can aid in carrying the clad glass composition over the overflow distributor to form the clad layer. Accordingly, the clad glass composition can have a liquidus viscosity that is lower than generally considered suitable for forming a single layer sheet using a fusion draw process.

A variety of processes may be used to produce the glass laminate 100 described herein including, without limitation, lamination slot draw processes, lamination float processes, or fusion lamination processes. Each of these lamination processes generally involves flowing a first molten glass composition, flowing a second molten glass composition, and contacting the first molten glass composition with the second molten glass composition at a temperature greater than the glass transition temperature of either glass composition to form an interface between the two compositions such that the first and second molten glass compositions fuse together at the interface as the glass cools and solidifies. In an exemplary embodiment, the glass laminate 100 described herein can be formed by a fusion lamination process such as the process described in U.S. Pat. No. 4,214,886, issued on Jul. 29, 1980, which is incorporated herein by reference in its entirety.

Referring to FIG. 4 by way of example, a laminate fusion draw apparatus 300 for forming a laminated glass article is shown. For example, the fusion draw apparatus 300 includes a lower overflow distributor 320 and an upper overflow distributor 340 positioned above the lower overflow distributor 320. The lower overflow distributor 320 includes a trough 322. A core glass composition 324 is melted and fed into the trough 322 in a viscous state. The core glass composition 324 forms the glass core layer 102 of the glass laminate 100 as further described below. The upper overflow distributor 340 includes a trough 342. A clad glass composition 344 is melted and fed into the trough 342 in a viscous state. The clad glass composition 344 forms first and second glass clad layers 104, 106 of the glass laminate 100 as further described below.

The core glass composition 324 overflows trough 322 and flows down opposing outer forming surfaces 326 and 328 of the lower overflow distributor 320. The outer forming surfaces 326 and 328 converge at a draw line or root 330. The separate streams of the core glass composition 324 flowing down respective outer forming surfaces 326 and 328 of the lower overflow distributor 320 converge at the draw line 330 where they are fused together to form the core layer 102 of the glass laminate 100.

The clad glass composition 324 overflows the trough 342 and flows down opposing outer forming surfaces 346 and 348 of the upper overflow distributor 340. The clad glass composition 344 is deflected outward by the upper overflow distributor 340 such that the clad glass composition 344 flows around the lower overflow distributor 320 and contacts the core glass composition 324 flowing over the outer forming surfaces 326 and 328 of the lower overflow distributor 320. The separate streams of the clad glass composition 344 are fused to the respective separate streams of the core glass composition 324 flowing down the respective outer forming surfaces 326 and 388 of the lower overflow distributor 320. Upon convergence of the streams of the core glass composition 324 at the draw line 330, the clad glass composition 344 forms first and second glass clad layers 104, 106 of the glass laminate 100.

In embodiments, the core glass composition 324 of the glass core layer 102 in the viscous state is contacted with the clad glass composition 344 of the first and second glass clad layers 104, 106 in the viscous state to form the laminated sheet. In some of such embodiments, the laminated sheet is part of a glass ribbon traveling away from the draw line 330 of the lower overflow distributor 320, as shown in FIG. 4. The glass ribbon can be drawn away from the lower overflow distributor 320 by a suitable means including, for example, gravity and/or pulling rollers. The glass ribbon cools as it travels away from the lower overflow distributor 320. The glass ribbon is severed to separate the laminated sheet therefrom. Thus, the laminated sheet is cut from the glass ribbon. The glass ribbon can be severed using a suitable technique such as, for example, scoring, bending, thermally shocking, and/or laser cutting. In embodiments, the glass laminate 100 comprises the laminated sheet as shown in FIG. 1. In other embodiments, the laminated sheet can be processed further (e.g., by cutting or molding) to form the glass laminate.

Although the glass laminate 100 is shown in FIG. 1 as including three layers, other embodiments are contemplated. For example, the glass laminate may have two, four, or more layers. Glass laminates including two layers can be formed using two overflow distributors positioned such that the two layers are joined while traveling away from the respective draw lines of the overflow distributors or by using a single overflow distributor with a divided trough such that two glass compositions flow over opposing outer forming surfaces of the overflow distributor and converge at the draw line of the overflow distributor. Glass laminates including four layers can be formed using additional overflow distributors and/or using overflow distributors with divided troughs. Thus, a glass laminate having a predetermined number of layers can be formed by modifying the overflow distributor accordingly.

Referring still to FIG. 1, the coefficient of thermal expansion CTE_{G1} of the first glass-based layer 204a can be substantially different than the effective coefficient of thermal expansion CTE_{GL} of the glass laminate 100. For example, the coefficient of thermal expansion CTE_{G1} of first glass-based layer 204a can be relatively low while the coefficient of thermal expansion CTE_{GL} of the glass laminate 100 is higher than that of the first glass-based layer 204a. The first polymer layer 202a can comprise a UV- or thermal-curable polymer. Curing the polymer at a curing temperature distanced from a (intended) usage temperature (e.g., room temperature) leads to the CTE differential between the glass-based layers to form a compressive stress on the first glass-based layer 204a as the glass-based article 10 is returned to the usage temperature. The compressive stress on the first glass-based layer 204a provides increased damage resistance and improved scratch performance. Any cracks that may form in the first glass-based layer 204a are arrested at the polymer interface due to the ductile deformation of the first polymer layer 202a and may not propagate into the glass laminate 100, reducing the visibility of the cracks and preventing catastrophic failure of the glass-based article 10.

The first glass-based layer 204a can be configured to be thin (e.g., such that a thickness t_{G1} thereof is less than or equal to 300 μm) to aid in minimizing the visibility of any cracks formed therein. The use of a damage resistant material, such as borosilicates, alkaline earth aluminoborosilicates, alkali aluminoborosilicates, other optional damage-resistant silicates, and petalite glass ceramics, to form the first glass-based layer 204a provides further improved impact performance than monolithic ion exchanged glass materials, which can be more prone to lateral cracking because of their large surface stress gradient.

In embodiments, the material from which the first polymer layer 202a is formed is selected to be stiff at relatively low thicknesses, preventing sharp flexure and breakage of the first glass-based layer 204a and the glass laminate 100. Polymers having relatively high elastic moduli, relatively high glass transition temperatures, and relatively low ductile to brittle transformation temperature have been found to beneficially effect performance. In addition to a variety of UV- and thermally-curable polymers, film polymer laminations can be employed. Commercially available polymers, such as those described in International Patent Application No. PCT/US2021/060757, filed on Nov. 24, 2021, which is incorporated herein by reference in its entirety, can be used to form the polymer layers described herein.

Referring still to FIG. 1, the glass-based article 10 has a laminate structure (e.g., glass-based layers and polymer layers) that provides several advantages when compared to monolithic chemically or thermally strengthened glass-based articles, such as those that are commercially available. The laminate structure provides performance comparable to that of chemically strengthened glass-based articles without requiring an ion exchange treatment, reducing cost for the same level of performance. Additionally, the visibility of defects in the glass-based article 10 is less objectionable over a broader range of impact events than monolithic chemically strengthened glass-based articles, reducing the frequency of replacement during usage. The glass-based article 10 may also exhibit some degree of self-healing, such that cracks that do form become less visible over time, due to the compressive stress in the first glass-based layer 204a. From a fabrication perspective, the glass-based article 10 described herein may be cut from “mother” sheets to desired part size even after the introduction of the compressive stress, which is difficult or impossible with monolithic chemically strengthened glass-based articles. The glass-based article 10 may also be considered repairable, such that the application of a curable resin may reduce the appearance of cracks.

In embodiments, a portion (e.g., a first additive portion) of the compressive stress in the first glass-based layer 204a originates or arises from a differential between CTE_{G1} (e.g., the coefficient of thermal expansion of the first glass-based layer 204a) and CTE_{GL} (e.g., the effective coefficient of thermal expansion of the glass laminate 100). The material of the first polymer layer 202a is cured at a curing temperature T_{C} (e.g., heated to a curing temperature) different than the (intended) usage temperature T_{U} (e.g., room temperature or temperatures or temperature ranges higher or lower than room temperature). As the glass-based article 10 is returned to the usage temperature T_{U} after the curing, the volumetric change of the glass laminate 100 is larger than the volumetric change of the first glass-based layer 204a (e.g., when CTE_{GL}>CTE_{G1}), which produces a compressive stress in the first glass-based layer 204a.

In embodiments, the greater the differential between CTE_{GL} (e.g., the effective coefficient of thermal expansion of the glass laminate 100) and CTE_{G1} (e.g., the coefficient of thermal expansion of the first glass-based layer 204a), and the greater the difference between the curing temperature T_{C} and the usage temperature TU, the greater the compressive stress produced in the first glass-based layer 204a. In addition to the CTE differential between the glasses of the first glass-based layer 204a and the glass laminate 100, the glass relaxation behavior of the polymer from which the first polymer layer 202a is formed influences the final stress state in the glass-based article 10. In particular, the glass transition temperature, processing temperature, cooling rate, and elastic modulus of the polymer in various states (e.g., the rubbery state) are relevant controlling parameters.

The first polymer layer 202a serves multiple purposes. For example, the first polymer layer 202a provides the mechanical bond between the first glass-based layer 204a and the glass laminate 100. The shrinkage of the first polymer layer 202a during the curing process can impart an additional compressive force on the first glass-based layer 204a and the glass laminate 100 to which it is bonded such that glass-based articles described herein may exhibit slightly more compressive stress than attributable only to the CTE mismatch between the first glass-based layer 204a and the glass laminate 100. This additional compression adds to the damage resistance and strength of the glass-based article 10. Additionally, the first polymer layer 204a deflects and arrests cracks that may propagate from one glass-based layer into another. Thus, if the surface of the glass laminate 100 is pristine and free of strength limiting flaws, it is expected to remain so during use because the surface is protected by the first glass-based layer 204a and first polymer layer 202a, imparting great strength to the glass-based article 10 even if the first glass-based layer 204a is insulted or damaged. To provide such protection, the polymer ductile-to-brittle transformation temperature should be low, such that the deformation in the first polymer layer 202a is either purely elastic or elastic/plastic/viscoplastic within the usage temperature (e.g., from −30° C. to 50° C., from −10° C. to 50° C., or from 0° C. to 30° C.). The first polymer layer 202a also helps to hold closed any cracks that do form in the glass-based layers.

As shown in FIG. 1, the first glass-based layer 204a comprises the thickness t_{G1}. The first glass-based layer 204a can be formed from a first glass composition (e.g., the damage resistant materials disclosed above) and comprise the coefficient of thermal expansion CTE_{G1}. The glass laminate 100 comprises the (total) thickness t_{GL} (e.g., between the outer surface 108 of the first glass clad layer 104 and the outer surface 110 of the second glass clad layer 106). The glass laminate 100 can be formed from various glass compositions (e.g., the clad glass compositions and the core glass compositions disclosed above) and comprise the effective coefficient of thermal expansion CTE_{GL}. The first polymer layer 202a comprises the thickness tri and the coefficient of thermal expansion CTE_{P1}. In embodiments, the differential between CTE_{G1} and CTE_{G1} is greater than or equal to 0.4 ppm/° C. (e.g., |CTE_{GL}−CTE_{G1}|?0.4 ppm/° C.) or greater than or equal to 0.5 ppm/° C. (e.g., |CTE_{GL}−CTE_{G1}|≥0.5 ppm/° C.) to impart strength-enhancing compressive stress in the first glass-based layer 204a after lamination (e.g., after the first composite layer 200a is attached to the glass laminate 100).

In embodiments, the thickness t_{P1} of the first polymer layer 202a, the thickness t_{G1} of first glass-based layer 204a, and the thickness t_{GL} of the glass laminate 100 can have the relationship t_{P1}<t_{G1}<t_{GL}.

In embodiments, the glass-based articles disclosed herein include at least one glass-based layer with a thickness of less than or equal to 300 μm, such as less than or equal to 200 μm. The low thicknesses of the glass-based layers allow the layers to bend and dissipate impact energy, reducing or preventing fracture. Additionally, the thinness of the glass-based layers may reduce the visibility of any cracks that do form in the glass-based layers. In embodiments, the first glass-based layer 204a has a thickness t_{G1} of less than or equal to 300 μm, such as less than or equal to 200 μm, less than or equal to 190 μm, less than or equal to 180 μm, less than or equal to 170 μm, less than or equal to 160 μm, less than or equal to 150 μm, less than or equal to 140 μm, less than or equal to 130 μm, less than or equal to 120 μm, less than or equal to 110 μm, less than or equal to 100 μm, less than or equal to 90 μm, or less. In embodiments, the first glass-based layer 204a has a thickness t_{G1} of from greater than or equal to 90 μm to less than or equal to 300 μm, such as from greater than or equal to 90 μm to less than or equal to 200 μm, from greater than or equal to 100 μm to less than or equal to 190 μm, from greater than or equal to 110 μm to less than or equal to 180 μm, from greater than or equal to 120 μm to less than or equal to 170 μm, from greater than or equal to 130 μm to less than or equal to 160 μm, from greater than or equal to 140 μm to less than or equal to 150 μm, and any and all sub-ranges formed from any of these endpoints.

In embodiments, the glass-based articles disclosed herein include at least one glass-based layer with a thickness of greater than or equal to 200 μm, such as greater than or equal to 300 μm. The glass-based layers with relatively higher thicknesses increases the resistance of the glass-based articles to crack growth. In embodiments, the glass laminate 100 has a (total) thickness t_{GL} of greater than or equal to 200 μm (0.200 mm), such as greater than or equal to 300 μm (0.300 mm), greater than or equal to 350 μm (0.350 mm), greater than or equal to 400 μm (0.400 mm), greater than or equal to 450 μm (0.450 mm), greater than or equal to 500 μm (0.500 mm), greater than or equal to 550 μm (0.550 mm), greater than or equal to 600 μm (0.600 mm), greater than or equal to 650 μm (0.650 mm), greater than or equal to 700 μm (0.700 mm), greater than or equal to 750 μm (0.750 mm), greater than or equal to 800 μm (0.800 mm), greater than or equal to 850 μm (0.850 mm), greater than or equal to 900 μm (0.900 mm), greater than or equal to 950 μm (0.950 mm), greater than or equal to 1000 μm (1.000 mm), greater than or equal to 1050 μm (1.050 mm), greater than or equal to 1100 μm (1.100 mm), greater than or equal to 1150 μm (1.150 mm), greater than or equal to 1200 μm (1.200 mm), greater than or equal to 1250 μm (1.250 mm), greater than or equal to 1300 μm (1.300 mm), greater than or equal to 1350 μm (1.350 mm), greater than or equal to 1400 μm (1.400 mm), greater than or equal to 1450 μm (1.450 mm), greater than or equal to 1500 μm (1.500 mm), greater than or equal to 1550 μm (1.550 mm), greater than or equal to 1600 μm (1.600 mm), greater than or equal to 1650 μm (1.650 mm), greater than or equal to 1700 μm (1.700 mm), greater than or equal to 1750 μm (1.750 mm), greater than or equal to 1800 μm (1.800 mm), greater than or equal to 1850 μm (1.850 mm), greater than or equal to 1900 μm (1.900 mm), greater than or equal to 1950 μm (1.950 mm), greater than or equal to 2000 μm (2.000 mm), or more.

In embodiments, the glass laminate 100 has a (total) thickness t_{GL}, of from greater than or equal to 200 μm (0.200 mm) to less than or equal to 3800 μm (3.800 mm), such as greater than or equal to 300 μm (0.300 mm) to less than or equal to 3000 μm (3.000 mm), greater than or equal to 350 μm (0.350 mm) to less than or equal to 2500 μm (2.500 mm), greater than or equal to 400 μm (0.400 mm) to less than or equal to 2000 μm (2.000 mm), greater than or equal to 450 μm (0.450 mm) to less than or equal to 1850 μm (1.850 mm), greater than or equal to 500 μm (0.500 mm) to less than or equal to 1800 μm (1.800 mm), greater than or equal to 550 μm (0.550 mm) to less than or equal to 1750 μm (1.750 mm), greater than or equal to 600 μm (0.600 mm) to less than or equal to 1700 μm (1.700 mm), greater than or equal to 650 μm (0.650 mm) to less than or equal to 1650 μm (1.650 mm), greater than or equal to 700 μm (0.700 mm) to less than or equal to 1600 μm (1.600 mm), greater than or equal to 750 μm (0.750 mm) to less than or equal to 1550 μm (1.550 mm), greater than or equal to 800 μm (0.800 mm) to less than or equal to 1500 μm (1.500 mm), greater than or equal to 850 μm (0.850 mm) to less than or equal to 1450 μm (1.450 mm), greater than or equal to 900 μm (0.900 mm) to less than or equal to 1400 μm (1.400 mm), greater than or equal to 950 μm (0.950 mm) to less than or equal to 1350 μm (1.350 mm), greater than or equal to 1000 μm (1.000 mm) to less than or equal to 1300 μm (1.300 mm), greater than or equal to 1050 μm (1.050 mm) to less than or equal to 1250 μm (1.250 mm), greater than or equal to 1100 μm (1.100 mm) to less than or equal to 1200 μm (1.200 mm), greater than or equal to 1150 μm (1.150 mm) to less than or equal to 1175 μm (1.175 mm), and any and all sub-ranges formed from any of these endpoints.

The relatively low thickness t_{G1} of the first glass-based layer 204a may render any impact-induced damage on the outer surface 208a less visible by preventing cracks from twisting out of plane and covering more surface area along the plane of the first glass-based layer, thereby reducing the scattering cross-section of the damage. The relatively low thickness t_{G1} of the first glass-based layer 204a may also allow the first glass-based layer 204a to bend and dissipate impact energy, reducing or preventing fracture. The relatively high thickness t_{GL} of the glass laminate 100 adds stiffness to the glass-based article and prevents warpage from the lamination process, particularly in embodiments of the article have an asymmetrical structure, such as the glass-based article 20 of FIG. 2 and the glass-based article 30 of FIG. 3 in which the glass-polymer composite layer(s) is/are disposed on one side of the glass laminate 100.

The polymer layer(s) is/are significantly thinner than the glass-based layers. In embodiments, all the polymer layers disposed between the glass-based layers in the glass-based articles may, individually, have a thickness of less than or equal to 10 μm. Without being bound by theory, it is believed that the thinner polymer layers enable a more rigid connection between the glass laminate 100 and the one or more glass-polymer composite layer 200a, 200b. Such a rigid connection may simulate the rigidity of a monolithic glass-substrate, which may be beneficial to arrest cracks and prevent visibility of flaws associated with cracks. In embodiments, the first polymer layer 202a may have a thickness t_{P1} of less than or equal to 9.9 μm, such as less than or equal to 9.6 μm, less than or equal to 9.3 μm, less than or equal to 9.0 μm, less than or equal to 8.6 μm, less than or equal to 8.3 μm, less than or equal to 8.0 μm, less than or equal to 7.7 μm, less than or equal to 7.4 μm, less than or equal to 6.7 μm, less than or equal to 6.4 μm, less than or equal to 6.1 μm, less than or equal to 5.8 μm, less than or equal to 5.4 μm, less than or equal to 5.1 μm, or less than or equal to 4.8 μm, less than or equal to 4 μm, less than or equal to 3 μm, less than or equal to 2 μm, less than or equal to 1 μm, or less.

In embodiments, the first polymer layer 202a may have a thickness t_{P1} of from greater than or equal to 0.1 μm to less than or equal to 10 μm, such as from greater than or equal to 0.2 μm to less than or equal to 9.9 μm, from greater than or equal to 0.4 μm to less than or equal to 9.6 μm, from greater than or equal to 0.6 μm to less than or equal to 9.3 μm, from greater than or equal to 0.8 μm to less than or equal to 9.0 μm, from greater than or equal to 1.0 μm to less than or equal to 8.6 μm, from greater than or equal to 1.2 μm to less than or equal to 8.3 μm, from greater than or equal to 1.4 μm to less than or equal to 8.0 μm, from greater than or equal to 1.6 μm to less than or equal to 7.7 μm, from greater than or equal to 1.8 μm to less than or equal to 7.4 μm, from greater than or equal to 2.0 μm to less than or equal to 7.0 μm, from greater than or equal to 2.2 μm to less than or equal to 6.7 μm, from greater than or equal to 2.4 μm to less than or equal to 6.4 μm, from greater than or equal to 2.6 μm to less than or equal to 6.1 μm, from greater than or equal to 2.8 μm to less than or equal to 5.8 μm, from greater than or equal to 3.0 μm to less than or equal to 5.4 μm, from greater than or equal to 3.2 μm to less than or equal to 5.1 μm, from greater than or equal to 3.4 μm to less than or equal to 4.8 μm, from greater than or equal to 3.6 μm to less than or equal to 4.7 μm, from greater than or equal to 3.8 μm to less than or equal to 4.6 μm, and any and all sub-ranges formed from these endpoints. Where multiple polymer layers are included in the glass-based article, the polymer layers in the glass-based article may have different thicknesses. In other embodiments, where multiple polymer layers are included in the glass-based article the polymer layers may have substantially equivalent or equivalent thicknesses.

Referring still to FIG. 1, the glass-based articles may have any appropriate thickness. The thickness t_{A} of the glass-based articles may be defined as the sum of the thickness of the layers included therein. For example, the thickness t_{A} of the glass-based article may be equivalent to t_{GL}+t_{CL1} for embodiments that include one glass-polymer composite layer 200, such as the glass-based article 20 of FIG. 2. The thickness t_{A} of the glass-based article may be equivalent to t_{GL}+t_{CL1}+t_{CL2} for embodiments that include two glass-polymer composite layers 200, such as the glass-based article 10 of FIG. 1 and the glass-based article 30 of FIG. 3. In embodiments, the thickness TA of the glass-based article is less than or equal to 20 mm, such as less than or equal to 19 mm, less than or equal to 18 mm, less than or equal to 17 mm, less than or equal to 16 mm, less than or equal to 15 mm, less than or equal to 14 mm, less than or equal to 13 mm, less than or equal to 12 mm, less than or equal to 11 mm, less than or equal to 10 mm, less than or equal to 9 mm, less than or equal to 8 mm, less than or equal to 7 mm, less than or equal to 6 mm, less than or equal to 5 mm, less than or equal to 4.5 mm, less than or equal to 4 mm, less than or equal to 3 mm, less than or equal to 2 mm, less than or equal to 1.5 mm, less than or equal to 1 mm, or less. In embodiments, the thickness t_{A} of the glass-based article is from greater than or equal to 0.5 mm to less than or equal to 20 mm, such as greater than or equal to 1 mm to less than or equal to 19 mm, greater than or equal to 2 mm to less than or equal to 18 mm, greater than or equal to 3 mm to less than or equal to 17 mm, greater than or equal to 4 mm to less than or equal to 16 mm, greater than or equal to 5 mm to less than or equal to 15 mm, greater than or equal to 6 mm to less than or equal to 14 mm, greater than or equal to 7 mm to less than or equal to 13 mm, greater than or equal to 8 mm to less than or equal to 12 mm, greater than or equal to 9 mm to less than or equal to 11 mm, greater than or equal to 0.5 mm to less than or equal to 10 mm, and any and all sub-ranges formed from these endpoints.

As described above, the first glass-base layer 204a and the glass laminate 100 have a coefficient of thermal expansion (CTE) mismatch. The difference in CTE between the first glass-based layer 204a and the glass laminate 100 is greater than 0.4 ppm/° C., such that |CTE_{GL}−CTE_{G1}|>0.4 ppm/° C. In embodiments, |CTE_{GL}−CTE_{G1}|>0.5 ppm/° C. or |CTE_{GL}−CTE_{G1}|>1 ppm/° C. In general, a greater mismatch in CTE of the glass-based layers produces greater amounts of compressive stress in the first glass-based layer 204a. In embodiments, CTE_{G1}<CTE_{GL}. In other embodiments, CTE_{G1}>CTE_{GL}. The glass-based layer with the higher CTE determines whether the curing of the polymer layer takes place above or below the usage temperature T_{U} to produce a compressive stress in the first glass-based layer. In embodiments, where CTE_{G1}<CTE_{GL} the curing temperature T_{C} is greater than the usage temperature T_{U}. In such embodiments, the mismatch between CTE_{G1} and CTE_{GL}, can be within a specified percentage, such as approximately 10%, and follow the relationship 0.9 CTE_{GL}≤CTE_{G1}<CTE_{GL}. In embodiments, where CTE_{G1}>CTE_{GL} the curing temperature T_{C} is lower than the usage temperature T_{U}. In such embodiments, the mismatch between CTE_{G1} and CTE_{GL} can be within a specified percentage, such as approximately 10%, and follow the relationship 0.9 CTE_{G1}≤CTE_{GL}<CTE_{G1}.

A relationship among CTE_{GL} (e.g., the coefficient of thermal expansion of the glass laminate 100), CTE_{G1} (e.g., the coefficient of thermal expansion of the first glass-based layer 204a), and CTE_{P1} (e.g., the coefficient of thermal expansion of the first polymer layer 202a) can also be considered as imparting a portion (e.g., a second additive portion) of the compressive stress in the first glass-based layer 204a. In embodiments, the relationship comprises CTE_{P1}−(CTE_{G1}+CTE_{GL})/2>1 ppm/° C.

In embodiments, the glass-based articles include the second composite layer 200b attached via the second polymer layer 202b to the glass laminate 100 or the first composite layer 200b. As described above, the second composite layer 200b comprises the second polymer layer 202b and the second glass-based layer 204b attached to the second polymer layer 202b. In the exemplary embodiment shown in FIG. 1, the second composite layer 200b is attached to the glass laminate 100 on a side opposite the side on which the first composite layer 200a is attached to the glass laminate 100. The second glass-based layer 204b has a thickness t_{G2} and a coefficient of thermal expansion CTE_{G2}, and the second polymer layer 202b has a thickness t_{P2} and a coefficient of thermal expansion CTE_{P2}.

In embodiments, a difference between CTE_{G2} (e.g., the coefficient of thermal expansion of the second glass-based layer 204b) and CTE_{GL} (e.g., the coefficient of thermal expansion of the glass laminate 100) is greater than or equal to 0.4 ppm/° C., such as greater than or equal to 0.5 ppm/° C. The second glass-based layer 204b includes a compressive stress. The inclusion of a second glass-based layer may allow for higher compressive stress to be achieved while also reducing or avoiding warp induced by the stress created in the glass-based articles. In embodiments, the first glass-based layer 204a and the second glass-based layer 204b have the same composition. In embodiments, the first polymer layer 202a and the second polymer layer 202b have the same composition. Additional glass-based articles can include additional glass-based layers and polymer layers.

The second glass-based layer 204b may have the same thickness as the first glass-based layer 204a, such that t_{G2}=t_{G1}. Alternatively, the second glass-based layer 204b may have a different thickness than the first glass-based layer 204a, such that t_{G2}≠t_{G1}. In embodiments, the second glass-based layer 204b has any thickness indicated above for the first glass-based layer 204a when t_{G2}=t_{G1} or when t_{G2}≠t_{G1}. The second polymer layer 202b may have the same thickness as the first polymer layer, such that t_{P2}=t_{P1}. Alternatively, the second polymer layer 202b may have a different thickness than the first polymer layer 202a, such that t_{P2}≠t_{P1}. In embodiments, the second polymer layer 202b has any thickness indicated above for the first polymer layer 202a when t_{P2}=t_{P1} or when t_{P2}≠t_{P1}.

As described above, the first glass-based layer 204a comprises a compressive stress. The compressive stress improves the resistance of the glass-based article to fracture and reduces crack propagation. In embodiments, the first glass-based layer 204a comprises a compressive stress greater than or equal to 5 MPa, such as greater than or equal to 10 MPa, greater than or equal to 15 MPa, greater than or equal to 20 MPa, greater than or equal to 25 MPa, greater than or equal to 30 MPa, greater than or equal to 35 MPa, greater than or equal to 40 MPa, greater than or equal to 45 MPa, greater than or equal to 50 MPa, greater than or equal to 55 MPa, greater than or equal to 60 MPa, greater than or equal to 65 MPa, greater than or equal to 70 MPa, greater than or equal to 75 MPa, greater than or equal to 80 MPa, greater than or equal to 85 MPa, greater than or equal to 90 MPa, greater than or equal to 95 MPa, greater than or equal to 100 MPa, or more. In embodiments, the first glass-based layer 204a comprises a compressive stress from greater than or equal to 5 MPa to less than or equal to 100 MPa, such as greater than or equal to 10 MPa to less than or equal to 95 MPa, greater than or equal to 15 MPa to less than or equal to 90 MPa, greater than or equal to 20 MPa to less than or equal to 85 MPa, greater than or equal to 25 MPa to less than or equal to 80 MPa, greater than or equal to 30 MPa to less than or equal to 75 MPa, greater than or equal to 35 MPa to less than or equal to 70 MPa, greater than or equal to 40 MPa to less than or equal to 65 MPa, greater than or equal to 45 MPa to less than or equal to 60 MPa, greater than or equal to 50 MPa to less than or equal to 55 MPa, and any and all sub-ranges formed from these endpoints. Unless otherwise indicated, the compressive stress is measured with a scattered light polariscope (SCALP) according to ASTM C1279:2013.

In embodiments, the compressive stress of the first glass-based layer 204a is greater than or equal to 5 MPa and less than or equal to 40 MPa. Without being bound by theory, it has been found that maintaining the compressive stress in this range is advantageous in that the tensile stress in the glass laminate 100 can be maintained at levels less than or equal to 10 MPa (e.g., less than or equal to 9.5 MPa, less than or equal to 9.0 MPa, less than or equal to 8.5 MPa, less than or equal to 8.0 MPa, or less than or equal to 7.5 MPa). Higher levels of tensile stress in the glass laminate 100 may increase the risk of catastrophic failure of the glass-based article in response to particularly severe impact events, due to the propensity of such tensile stress to propagate flaws.

In embodiments, the first glass-based layer 204a may comprise a substantially uniform compressive stress. In embodiments, the first glass-based layer 204a comprises an average compressive stress and the compressive stress varies over the thickness t_{G1} of the first glass-based layer 204a by less than 20% of the average compressive stress. In such embodiments, the average compressive stress of the first glass-based layer 204a may be any of the compressive stress values described above, such as greater than or equal to 5 MPa, greater than or equal to 10 MPa, etc.

The first glass-based layer 204a may be characterized by an exposed surface compressive stress at the outer surface 208a. The outer surface 208a is not in contact with the first polymer layer 202a and may be contacted during impact events such that it is most likely to suffer damage during normal use. In embodiments, the exposed surface of the first glass-based layer 204a has a compressive stress that may be any of the compressive stress values described above, such as greater than or equal to 5 MPa, greater than or equal to 10 MPa, etc.

The first glass-based layer 204a may be characterized by a bonded surface compressive stress at a major surface thereof that is contact with the first polymer layer 202a. In embodiments, the bonded surface of the first glass-based layer 204a has a compressive stress that may be any of the compressive stress values described above, such as greater than or equal to 5 MPa, greater than or equal to 10 MPa, etc. In embodiments where the compressive stress in the first glass-based layer 204a is substantially uniform, the compressive stress at the outer surface 208a may be substantially equal to the compressive stress at the major surface that is in contact with the first polymer layer 202a.

In embodiments, the first glass-based layer 204a and the glass laminate 100 are not thermally or chemically strengthened. In other words, the glass compositions used to form the first glass-based layer 204a and the glass laminate 100 are not strengthened by immersion in a molten salt bath or subjected to thermal tempering heat treatments to form compressive stress not resulting from the CTE mismatch between the glass compositions. Such embodiments may beneficially eliminate processing steps and save costs.

The first glass-based layer 204a may be formed from a chemically strengthened glass-based material. Chemically strengthened glass-based materials include a stress profile that is additively combined with the compressive stress produced by the CTE mismatch of the glass-based layers, resulting in a maximum compressive stress in the first glass-based layer 204a that may be significantly higher than the compressive stress due to the CTE mismatch alone. In embodiments, the first glass-based layer 204a includes a compressive stress greater than or equal to 200 MPa, such as greater than or equal to 250 MPa, greater than or equal to 300 MPa, greater than or equal to 350 MPa, greater than or equal to 400 MPa, greater than or equal to 450 MPa, greater than or equal to 500 MPa, greater than or equal to 550 MPa, greater than or equal to 600 MPa, greater than or equal to 650 MPa, greater than or equal to 700 MPa, greater than or equal to 750 MPa, greater than or equal to 800 MPa, greater than or equal to 850 MPa, greater than or equal to 900 MPa, greater than or equal to 950 MPa, or more. In embodiments, the first glass-based layer 204a includes a compressive stress from greater than or equal to 200 MPa to less than or equal to 1000 MPa, such as greater than or equal to 250 MPa to less than or equal to 950 MPa, greater than or equal to 300 MPa to less than or equal to 900 MPa, greater than or equal to 350 MPa to less than or equal to 850 MPa, greater than or equal to 400 MPa to less than or equal to 800 MPa, greater than or equal to 450 MPa to less than or equal to 750 MPa, greater than or equal to 500 MPa to less than or equal to 700 MPa, greater than or equal to 550 MPa to less than or equal to 650 MPa, greater than or equal to 200 MPa to less than or equal to 600 MPa, and any and all sub-ranges formed from these endpoints.

In embodiments that include the second composite layer 200b, the second glass-based layer 204b may be characterized by the same compressive stress features as described above with respect to the first glass-based layer 204a. In embodiments, the second glass-based layer 204b includes a compressive stress substantially equivalent to the compressive stress of the first glass-based layer 204a.

The first glass-based layer 204a and glass laminate 100 may be selected to provide desirable optical properties. In embodiments, the glass-based layers have a transmission of greater than or equal to 90% over a wavelength range of interest. The wavelength range of interest may vary depending on the application. In embodiments, the glass-based articles disclosed herein can be used in connection with vehicle-mounted LiDAR systems.

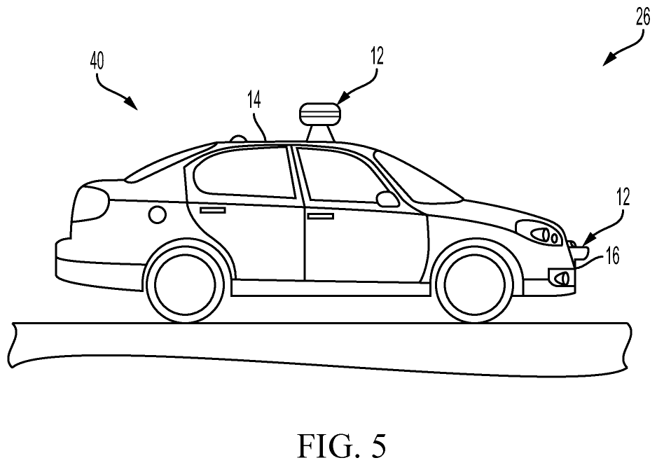

Referring now to FIG. 5, a vehicle 40 comprises one or more LiDAR systems 12. The one or more LiDAR systems 12 can be disposed anywhere on or within the vehicle 40. For example, the one or more LiDAR systems 12 can be disposed on a roof 14 of the vehicle 40 and/or a forward portion 16 of the vehicle 40.

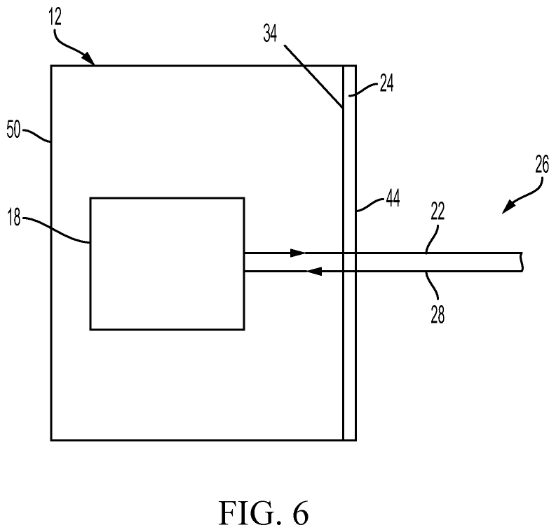

Referring now to FIG. 6, each of the one or more LiDAR systems 12 comprises an electromagnetic radiation emitter and sensor 18, as known in the art, which may be enclosed in an enclosure 50. The electromagnetic radiation emitter and sensor 18 emits emitted radiation 22 having a wavelength or range of wavelengths. The emitted radiation 22 exits the enclosure 50 through a window 24. If an object (not illustrated) in an external environment 26 is in the path of the emitted radiation 22, the emitted radiation 22 will reflect off the object and return to the electromagnetic radiation emitter and sensor 18 as reflected radiation 28, being initially incident on an outer surface 44 of the window. The outer surface 44 is the surface of the window 24 that is exposed (or most proximate to) the external environment of the LiDAR system 12, such that the outer surface 44 is exposed to conditions that are not regulated within the enclosure 50. After being incident on the outer surface 44, the reflected radiation 28 again passes through the window 24 to reach the electromagnetic radiation emitter and sensor 18. In embodiments, the emitted radiation 22 and the reflected radiation 28 has a wavelength of 905 nm or 1550 nm or has a bandwidth comprising either 905 nm (e.g., from 880 nm to 930 nm) or 1550 nm (e.g., from 1525 nm to 1775 nm). Electromagnetic radiation other than the reflected radiation 28 (such as electromagnetic radiation having wavelengths in the visible spectrum) may or may not pass through the window 24, depending on the optical properties of the window 24 as described herein. As used herein, the term “visible spectrum” is used to refer to the portion of the electromagnetic spectrum that is visible to the human eye and generally refers to electromagnetic radiation having a wavelength within the range of about 380 nm to 700 nm.

In embodiments, the window 24 for each of the one or more LiDAR systems 12 may comprise the glass-based articles 10, 20, 30 disclosed herein. In embodiments, and with reference to FIGS. 1-3 in connection with FIG. 6, the outer surface 208a of the first glass-based layer 204a (e.g., associated with the glass-based article 10 of FIG. 1 or the glass-based article 20 of FIG. 2) can correspond to the outer surface 44 of the window 24, or the outer surface 208b of the second glass-based layer 204b (e.g., associated with the glass-based article 30 of FIG. 3) can correspond to the outer surface 44 of the window 24. In embodiments, the outer surface 208b of the second glass-based layer 204b (e.g., associated with the glass-based article 10 of FIG. 1) can correspond to an inner surface 34 of the window 24, or the outer surface 110 of the second glass clad layer 106 (e.g., associated with the glass-based article 20 of FIG. 2 or the glass-based article 30 of FIG. 3) can correspond to the inner surface 34 of the window 24. In embodiments, the outer surface 44 is closest to the external environment 26, and the inner surface 34 is closest to the electromagnetic radiation emitter and sensor 18. The emitted radiation 22 encounters the inner surface 34 before the outer surface 44. The reflected radiation 28 encounters the outer surface 44 before the inner surface 34.

In embodiments, one or more of the inner surface 34 and the outer surface 44 of the window 24 may comprise one or more suitable surface treatments. For example, in embodiments, at least one of the inner surface 34 and the outer surface 44 comprises an anti-reflective film. The anti-reflective film(s) may be tailored to prevent reflection of the emitted radiation 22 and the reflected radiation 28. In embodiments, the anti-reflective film comprises a plurality of alternating layers of relatively low and high refractive index materials of suitable thickness to provide relatively low reflectance and high transmittance at within a particular wavelength range of interest. Any of the anti-reflective films described in International Patent Application No. PCT/US2020/035034, filed on May 29, 2020, International Patent Application No. PCT/US2020/035497, filed on Jun. 1, 2020, U.S. Provisional Patent Application No. 63/284,161, filed on Nov. 30, 2021, and U.S. Provisional Patent Application No. 63/289,828, filed on Dec. 15, 2021, each of which is incorporated herein by reference in its entirety, may be used in conjunction with the glass-based article. In embodiments, one of the high refractive index layers of the anti-reflective film comprises a relatively high thickness of 1000 nm, such that the glass-based article has a maximum hardness, measured by the Berkovich Indenter Hardness Test, of at least 8 GPa, when measured on the side of the anti-reflective film. As such, the construction of the anti-reflective film may enhance the impact performance of the glass-based article.

When the glass-based articles disclosed herein are used as the window 24 of the LiDAR system 12 shown in FIG. 5 and FIG. 6, the wavelength range of interest may comprise 905 nim or 1550 nm. In embodiments, the wavelength range of interest comprises a central wavelength of 905 nm or 1550 nm, and a range of wavelengths surrounding the central wavelength (e.g., +/−10 nm, +/−20 rim, +/−30 nm, +/−40 nm, +/−50 nm, +/−100 nm). In embodiments, such as for applications other than in the LiDAR system 12 (e.g., a camera cover lens), the wavelength range of interest may be the visible spectrum, or from 380 rim to 700 nm. In embodiments, the optical transmission throughout the wavelength range of interest may be greater than or equal to 91%, greater than or equal to 92%, greater than or equal to 93%, greater than or equal to 94%, greater than or equal to 95%, greater than or equal to 96%, greater than or equal to 97%, greater than or equal to 98%, greater than or equal to 99%, or more. Unless otherwise indicated, transmission is measured with a Haze-gard Transparency Transmission Haze Meter, according to ASTM D1003 using Illuminant C.

In embodiments, the glass-based layers may comprise glass compositions produced in accordance with U.S. Pat. No. 7,851,394, issued on Dec. 14, 2010, and/or U.S. Pat. No. 7,534,734, issued on May 19, 2009, each of which is incorporated herein by reference in its entirety. In embodiments, the glass-based layers may have alkali aluminosilicate compositions, such as those commonly subjected to ion exchange strengthening processes and used in mobile electronic devices. The alkali aluminosilicate glasses may be used in the glass-based articles in ion exchanged or non-ion exchanged form. In embodiments, the alkali aluminosilicate glass-based layers may be substantially free or free of lithium. The glass-based layers may comprise glass compositions in accordance with U.S. Pat. No. 9,156,724, issued on Oct. 13, 2015, which is incorporated herein by reference in its entirety.

In embodiments, the first glass-based layer 204a is formed from a glass composition that exhibits an anomalous fracturing behavior. An anomalous glass is a glass that tends to exhibit crack-loop fracture behavior where ring cracks surround an initial indention site when the glass is subjected to the Vickers indenter test described in Gross et al., Crack-resistant glass with high shear band density, Journal of Non-Crystalline Solids, 494 (2018) 13-20; and Gross, Deformation and cracking behavior of glasses indented with diamond tips of various sharpness. Journal of Non-Crystalline Solids, 358 (2012) 3445-3452, both of which are incorporated in their entireties. Examples of anomalous glass may be borosilicate glasses (such as the glasses described in PCT Patent Application No. PCT/US2021/061966, filed on Dec. 6, 2021, which is incorporated herein by reference in its entirety) and Eagle XG® or the clad glass composition of Example 1 (e.g., described later in this disclosure) manufactured by Corning Incorporated. Such glasses tend to exhibit impact performance characteristics that are favorable over glasses exhibiting normal fracture behavior, where cracks extending radially from the indentation site tend to extend through the thickness of the glass, potentially leading to catastrophic failure. Anomalous glasses such as borosilicates may also tend to exhibit relatively low CTEs, limiting thermally-induced damage from environmental exposure.

The first polymer layer 202a may be formed from any appropriate polymer material. In embodiments, the first polymer layer 202a may comprise a resin, such as an optically clear resin, such as a commercially available resin commonly utilized to repair windshields. In embodiments, the first polymer layer 202a may comprise an ultraviolet (UV) curable resin or a heat curable resin. In embodiments, the first polymer layer 202a may comprise an epoxy or an acrylate. In embodiments, the first polymer layer 202a may also comprise photoinitiators to provide the desired curing behavior. In embodiments in which the glass-based article includes multiple polymer layers (e.g., the glass-based article 10 of FIG. 1 or the glass-based article 30 of FIG. 3), the polymer layers may be formed from the same material or from different materials. It should be generally understood that any properties described herein with reference to the first polymer layer 202a may also be ascribed to any other polymer layers comprised in the glass-based articles (e.g., the second polymer layer 202b).

The materials used to form the first polymer layer 202a (and any other polymer layers present) may be characterized based on the glass transition temperature. The glass transition temperature influences the compressive stress produced because of the CTE mismatch between the first glass-based layers 204a and the glass laminate 100. In embodiments, the first polymer layer 202a has a glass transition temperature T_{gP1} greater than or equal to 20° C., such as greater than or equal to 30° C., greater than or equal to 40° C. greater than or equal to 50° C., greater than or equal to 60° C., greater than or equal to 70° C., greater than or equal to 80° C. greater than or equal to 90° C. greater than or equal to 100° C., greater than or equal to 110° C., greater than or equal to 120° C., greater than or equal to 130° C., greater than or equal to 140° C., greater than or equal to 150° C., or more. In embodiments, the first polymer layer 202a has a glass transition temperature T_{gP1} from greater than or equal to 20° C. to less than or equal to 200° C. such as greater than or equal to 30° C. to less than or equal to 190° C., greater than or equal to 40° C. to less than or equal to 180° C., greater than or equal to 50° C. to less than or equal to 170° C., greater than or equal to 60° C. to less than or equal to 160° C. greater than or equal to 70° C. to less than or equal to 150° C., greater than or equal to 80° C. to less than or equal to 140° C., greater than or equal to 90° C. to less than or equal to 130° C., greater than or equal to 100° C. to less than or equal to 120° C., greater than or equal to 20° C. to less than or equal to 110° C., and any and all sub-ranges formed from these endpoints. Unless otherwise indicated, the glass transition temperature of the polymer is measured by dynamic mechanical analysis.

The first polymer layer 202a may also be characterized based on the storage modulus. In embodiments, the storage modulus of the first polymer layer 202a at temperatures between 0° C. and 40° C. is greater than or equal to 5 MPa and less than or equal to 20,000 MPa, such as greater than or equal to 2,000 MPa and less than or equal to 5,000 MPa, and all sub-ranges formed from these endpoints.

In embodiments, the first polymer layer 202a does not exhibit brittle deformation behavior at 20° C. In other words, the first polymer layer 202a may exhibit ductile deformation behavior at 20° C. The non-brittle deformation behavior of the first polymer layer 202a can help prevents cracks from extending from one glass-based layer (e.g., the first glass-based layer 204a) through the polymer layer to another glass-based layer (e.g., the glass laminate 100), also referred to as arresting the cracks.

The first polymer layer 202a may have optical properties that are compatible with the first glass-based layer 204a and the glass laminate 100. In embodiments, the first polymer layer 202a may have a transmission of greater than or equal to 90% over a wavelength range of interest, as described herein. In embodiments, the material from which the first polymer layer 202a is constructed is selected to have a post-curing refractive index n_{P1}, measured at 550 nm. In embodiments, n_{P1} is selected to substantially match a refractive index n_{G1} of the first glass-based layer 204a, measured at 550 nm, and/or a refractive index n_{GL} of the glass laminate 100, measured at 550 nm. In embodiments, n_{P1}−n_{G1} is less than or equal to 0.3 (e.g., less than or equal to 0.2 or less than or equal to 0.1) at 550 nm. In embodiments, n_{P1}−n_{GL} is less than or equal to 0.3 (e.g., less than or equal to 0.2 or less than or equal to 0.1). In embodiments, n_{P1} is preferably selected to be within 0.1 of n_{G1}. Such index matching may render any impact-induced flaws in the first glass-based layer 204a difficult to see by avoiding index contrast-induced reflections at the interface between the first glass-layer 204a and the first polymer layer 202a. However, when the first polymer layer 202a is relatively thin (e.g., less than or equal to 10 μm) such index matching may not be necessary to reduce visibility of flaws.

The first polymer layer 202a may be relatively stiff, such as a polymer with an elastic modulus greater than or equal to 100 MPa at a strain rate of 1/s. The stiffness of the first polymer layer 202a may constrain the glass-based layers, preventing the growth of cracks in the glass-based layers and preventing the glass-based layers from flexing and breaking. The first polymer layer 202a may have an elastic modulus greater than or equal to 100 MPa at a strain rate of 1/s, such as greater than or equal to 105 MPa, greater than or equal to 110 MPa, greater than or equal to 115 MPa, greater than or equal to 120 MPa, greater than or equal to 125 MPa, or more. In embodiments, the stiffness of the polymer layer may be related to the thickness of the polymer layer, such that the elastic modulus of the polymer layer divided by the thickness of the polymer layer is greater than or equal to 1 MPa/μm, such as greater than or equal to 2 MPa/μm, greater than or equal to 3 MPa/μm, greater than or equal to 4 MPa/μm, greater than or equal to 5 MPa/μm, greater than or equal to 6 MPa/μm, greater than or equal to 7 MPa/μm, greater than or equal to 8 MPa/μm, greater than or equal to 9 MPa/μm, greater than or equal to 10 MPa/μm, or more. Unless otherwise indicated, the elastic modulus of the polymer is measured by dynamic mechanical analysis.

The first polymer layer 202a may also be resistant to fracture. In embodiments, the polymer layers have a fracture toughness greater than or equal to 0.8 MPa√m, such as greater than or equal to 0.81 MPa√m, greater than or equal to 0.82 MPa√m, greater than or equal to 0.83 MPa√m, greater than or equal to 0.84 MPa√m, greater than or equal to 0.85 MPa√m, or more.

The first polymer layer 202a may also be characterized based on volume change as a function of temperature. This phenomenon is commonly referred to as shrinkage. The polymer may also exhibit shrinkage because of the curing process. In embodiments, the polymer undergoes a shrinkage of greater than or equal to 1% during the curing process, such as greater than or equal to 2%, greater than or equal to 3%, or more.

In embodiments, the first polymer layer 202a may comprise one or more additives to alter the properties thereof. In embodiments, the polymer layers may comprise carbon nanotubes, such as multi-walled carbon nanotubes. The inclusion of carbon nanotubes in the polymer layers may increase the resistance of the glass-based articles to fracture, such as indicated by a ball drop test. Without being bound by theory, the inclusion of carbon nanotubes in the polymer can increase the storage modulus, Young's modulus, and tensile strength of the polymer layer producing the improved crack resistance. In embodiments, the polymer layers may comprise carbon nanotubes in an amount of about 1%.

In embodiments, the first polymer layer 202a comprises one or more colorants. The inclusion of colorants in the first polymer layer 202a may impart a pleasing aesthetic appearance to the glass-based article as a whole without degrading the mechanical properties thereof. In embodiments, the polymer layer may comprise a colorant in the amount of greater than or equal to 0.1 wt % to less than or equal to 30 wt %. The colorant may be selected for compatibility with the composition of the polymer layer. For example, epoxy-based colorants may be employed when the polymer layer is an epoxy. For example, in the case of epoxy adhesives one can dope epoxy-based colorants such as Epoxicolor® series from Specialty Polymers & Services into the epoxy precursor mix at ranges of 0.1-30% by weight. Similarly, Orcozinedyes and OrcoTint NS dyes from Orco (Organic Dyes and Pigments) can also be used for acrylate-based adhesives. A suitable pigment dispersion (e.g., comprising a suitable pigment and monomer) may be incorporated into the material used to form the first polymer layer 202a.

In embodiments, the glass-based articles may appear transparent and colorless. In embodiments, the glass-based articles may have a transmission of grater than or equal to 90% over the wavelength range of 400 nm to 750 nm, such as greater than or equal to 91%, greater than or equal to 92%, greater than or equal to 93%, greater than or equal to 94%, greater than or equal to 95%, greater than or equal to 96%, greater than or equal to 97%, greater than or equal to 98%, greater than or equal to 99%, or more.

The glass-based articles may have any appropriate geometry. In embodiments, the glass-based articles are substantially flat or planar. In embodiments, the glass-based articles are curved. In embodiments, the glass-based articles may comprise openings or notches, such as openings to accommodate cameras, speakers, microphones, or finger-print sensors.

The glass-based articles may be produced by any appropriate lamination process. In general, the glass-based articles are produced by disposing a polymer layer between the glass-based layers 204a, 204b associated with the glass-polymer composite layers 200a, 200b and/or between the glass laminate 100 and an adjacent glass-based layer 204a, 204b associated with the glass-polymer composite layers 200a, 200b, and then curing the polymer layer in an environment at a curing temperature T_{C} that is different than the (intended) usage temperature Tu. In embodiments in which the glass-based articles include multiple glass-polymer composite layers 200 (e.g., the glass-based article 10 of FIG. 1 or the glass-based article 30 of FIG. 3), the disposing step can be repeated for each additional glass-based layer to be added to form a laminate stack. In embodiments in which more than one polymer layer is present, all the polymer layers can be cured concurrently.

The glass-based article may be cut or machined to a desired geometry after lamination and curing of the polymer layer. This allows large sheets of the glass-based articles to be formed and subsequently cut to the desired part size, increasing manufacturing efficiency and flexibility. After cutting the glass-based articles into the desired part size, edge finishing processes may be utilized to reduce the flaw population on the cut edges and produce an edge profile that is less susceptible to failure when the glass-based article is subjected to bending stresses. In embodiments, the glass-based layers may be cut and machined to a desired final geometry before assembly and curing of the laminate stack.

The disposition of the polymer layer may be carried out with any method capable of producing a polymer layer with the desired thickness. In embodiments, the polymer layer may be disposed using a doctor blade, roller, spray system, or any other technique known in the art. In embodiments, the polymer layers are disposed using flexographic or gravure printing techniques. Selecting appropriate disposition techniques allows the thickness of the polymer layer to be uniformly controlled. In embodiments, flexographic or gravure printing techniques are employed to produce a polymer layer with a thickness variation of less than or equal to 3 μm. The polymer layers may be formed from a liquid adhesive composition. In embodiments, the polymer layer may be deposited as a pre-formed film. After the polymer layer is disposed between the glass-based layers, pressure may be applied to the glass-based layers to remove any air bubbles or excess polymer from the laminate.

The curing of the polymer layer occurs in an environment at a curing temperature Tc, where the curing temperature is different than the (intended) usage temperature T_{U} (e.g., room temperature). After the polymer layer is cured, the glass-based article is returned to the (intended) usage temperature T_{U}, and the difference in CTE between the glass-based layers produces a compressive stress in the glass-based article, such as in the first glass-based layer 204a. In embodiments, the difference between T_{C} and room temperature (|T_{C}−20° C.) is greater than or equal to 10° C., such as greater than or equal to 15° C., greater than or equal to 20° C., greater than or equal to 25° C., greater than or equal to 30° C. greater than or equal to 35° C., greater than or equal to 40° C., greater than or equal to 45° C., greater than or equal to 50° C., greater than or equal to 55° C., greater than or equal to 60° C., greater than or equal to 65° C., greater than or equal to 70° C., greater than or equal to 75° C., greater than or equal to 80° C. greater than or equal to 85° C. greater than or equal to 90° C., greater than or equal to 95° C., greater than or equal to 100° C., greater than or equal to 105° C. greater than or equal to 110° C., greater than or equal to 115° C., greater than or equal to 120° C. or more.

The assembled laminate stack comprising the glass laminate 100 and the one or more glass-polymer composite layers 200 may be held in the environment at the curing temperature T_{C} for a period prior to curing the polymer, which may be referred to as pre-heating. This holding period allows the assembled laminate stack to substantially equilibrate to the curing temperature T_{C}. In embodiments, the assembled laminate stack may be maintained at the curing temperature T_{C} for greater than or equal to 2 minutes, such as greater than or equal to 3 minutes, greater than or equal to 4 minutes, greater than or equal to 5 minutes, greater than or equal to 6 minutes, greater than or equal to 7 minutes, greater than or equal to 8 minutes, greater than or equal to 9 minutes, greater than or equal to 10 minutes, or more.

In embodiments, the polymer layer may be cured by irradiating the polymer layer with ultraviolet (UV) radiation. In embodiments, the polymer layer may be cured by heat treating the polymer layer, such as by heating the assembled laminate stack as a whole or by locally heating the polymer layer. For example, the assembled laminate stack may be placed in an oven, in a furnace, or on a hot plate to heat treat and cure the polymer layer. In embodiments, a combination of UV radiation and heat treatment may be employed to cure the polymer layer. The UV irradiation for curing the polymer layer may extend for any time sufficient to produce the desired level of curing. In embodiments, the UV irradiation extends for a time period of greater than or equal to 0.5 min, such as greater than or equal to 1 min, greater than or equal to 2 min, greater than or equal to 3 min, greater than or equal to 4 min, greater than or equal to 5 min, greater than or equal to 6 min, greater than or equal to 7 min, greater than or equal to 8 min, greater than or equal to 9 min, greater than or equal to 10 min. or more. The curing may take place in any environment capable of maintaining the desired curing temperature and accommodating the glass-based articles. In embodiments, the curing takes place in an oven, furnace, refrigerator, freezer, or other environmental chamber.

The curing temperature may be above or below the intended usage temperature, with the relative CTE values of the glass-based layers selected accordingly to produce a compressive stress in the exposed glass-based layers, such as the first glass-based layer 204a. In embodiments, T_{C} is greater than or equal to 30° C. (e.g., greater than or equal to 50° C.) and CTE_{GL}>CTE_{G1}. In embodiments, T_{C} is less than or equal to 0° C. and CTE_{G1}>CTE_{GL}. The curing temperature T_{C} may also be selected based on the glass transition temperature of the polymer layer. In embodiments, the curing temperature T_{C} is great than or equal to 10° C. more than the glass transition temperature of the polymer layer (e.g., T_{C}≥T_{gP1}+10° C.).

The glass-based articles may be subjected to an additional ultraviolet (UV) irradiation after returning to the usage temperature T_{U}, such as room temperature. The additional UV irradiation ensures that the polymer layer is completely cured. In embodiments, the additional UV irradiation extends for a period of greater than or equal to 1 min, such as greater than or equal to 2 min, greater than or equal to 3 min, greater than or equal to 4 min, greater than or equal to 5 min, greater than or equal to 6 min, greater than or equal to 7 min, greater than or equal to 8 min, greater than or equal to 9 min, greater than or equal to 10 min, or more.

The process of producing the glass-based articles may comprise a heat treatment step after curing the polymer layer. In embodiments, the glass-based article is heated to a temperature greater than or equal to 40° C. after the polymer layer is cured. This additional heat treatment may assist in further curing the polymer layer.

The glass-based articles and methods of making the glass-based articles disclosed herein have numerous advantages. Under impact load from objects typically experienced in automotive applications (e.g., stones of various sharpness and weight, including sand particles, gravel, metal, hard polymers, concrete, etc.), the glass-based layer of the outer glass-polymer composite layer, having ultra-thin thickness and formed from anomalous glass compositions, may permit crack intrusion. However, due to the compressive stress and low thickness in the glass-based layers of the outer glass-polymer composite layer, the damage includes minimum visibility to no visibility. The underlying polymer layer of the outer glass-polymer composite layer absorbs part of the impact energy. If the impact energy is high enough, the defect may still penetrate through the glass-based layer and the polymer layer of the outer glass-polymer composite layer as those layers are thin. However, the inner glass laminate comprising clad glass layers fused to a core glass layer, is configured to be damage resistant and with a low central tension (CT) mechanism to prevent delayed crack extension/growth into the inner glass substrate. It has been found that the glass-based articles disclosed herein outperforms non-strengthened alternative glass solutions at least by a factor of two. Accordingly, the glass-based articles disclosed herein are configured to (1) significantly improve impact resistance and (2) prevent them from delayed failures due to crack extension/growth over time.

### Example

The various embodiments of the present disclosure can be better understood by reference to the following Example which is offered by way of illustration. The present disclosure is not limited to the Example given herein.

Sharp impact testing was performed on the following samples.

A conventional monolith (Comparative Example 1) was made from a glass substrate having a thickness of 2.1 mm and formed from an annealed soda lime glass (ASLG).

A conventional monolith (Comparative Example 2) was made from a glass substrate having a thickness of 3.8 mm and formed from a borosilicate glass that exhibits anomalous fracturing behavior.

A symmetrical glass-polymer laminate (Comparative Example 3) was made from (i) two external glass substrates each having a thickness of about 0.1 mm and formed from Corning® Eagle XG® glass, (ii) an internal glass substrate disposed between the two external glass substrates and having a thickness of about 0.55 mm and formed from soda lime glass (SLG), and (iii) two polymer layers each configured to attach one external glass substrate to the internal glass substrate and having a thickness that is less than 0.1 mm and consisting of 45 CPS Stone Chip Windshield Repair Resin produced by Ultra Bond, Inc (“UB45”) and cured at an elevated temperature of from about 90° C. to about 100° C.

An inventive glass-based laminate (Example 1) is configured similar to the glass-based article 10 described herein with respect to FIG. 1. Example 1 was made from two 0.1 mm thick outer glass layers formed from Corning® Eagle XG® glass disposed on opposite sides of a 1.5 mm thick inner glass laminate. The glass laminate was formed from two glass clad layers fused to a glass core layer and having a core/clad thickness ratio (R) of 4.0. Two UB45 polymer layers were disposed between the outer glass layers and the inner glass laminate. The glass core layer was formed from a core glass composition comprising: 56.57 wt % SiO₂, 16.75 wt % Al₂O₃, 10.27 wt % B₂O₃, 4.54 wt % CaO, 3.18 wt % K₂O, 3.79 wt % MgO, 4.74 wt % SrO, and 0.16 wt % SnO₂. The glass clad layers were each formed from a clad glass composition comprising: 60.19 wt % SiO₂, 11.66 wt % Al₂O₃, 17.75 wt % B₂O₃, 7.07 wt % CaO, 1.38 wt % MgO, 1.79 wt % SrO, and 0.16 wt % SnO₂.

The samples were supported on a perimeter frame that supported the samples at their periphery to allow the samples to flex upon impact. A Vickers diamond indenter (approximately 8.5 g) was dropped at a 90-degree angle to each sample. The drop height of the indenter was increased until radial cracks/fractures of >2.5 mm length measured in the plane of the glass surface were observed. The results of the sharp impact testing are presented as images of the different samples after impact testing with the images including numbers adjacent each impact location to indicate the drop height of the indenter that formed the impact. In general, the highest number in the image corresponds to the height at which radial fractures were observed (i.e., the failure height) unless there is a radial fracture clearly observable at a lower number. Impact locations and/or numbers that are crossed through with a marking means the impact location has been removed from consideration due to anomalies detected during testing or on the sample.

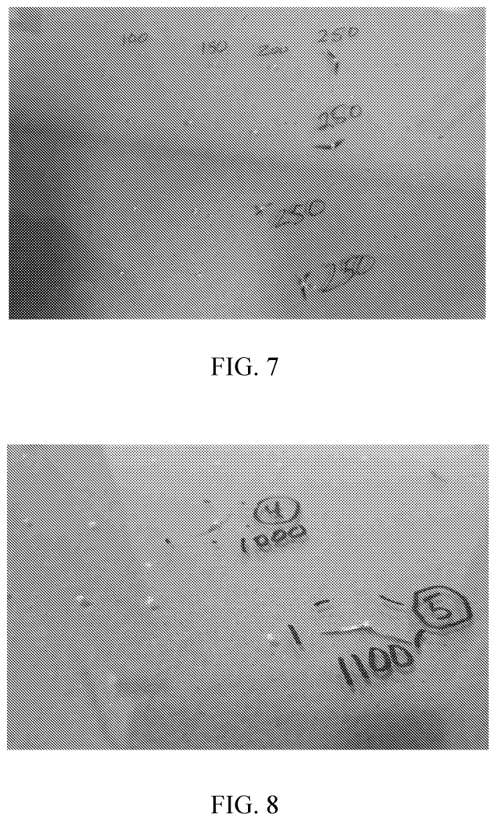

FIG. 7 is a digital image showing results of the sharp impact testing performed on Comparative Example 1. The failure height of Comparative Example 1, as shown in FIG. 7, is 250 mm. FIG. 8 is a digital image showing results of the sharp impact testing performed on Comparative Example 2. The failure height of Comparative Example 2, as shown in FIG. 8, is 1000 mm. FIG. 9 is a digital image showing results of the sharp impact testing performed on Comparative Example 3. The failure height of Comparative Example 3, as shown in FIG. 8, is 950 mm.

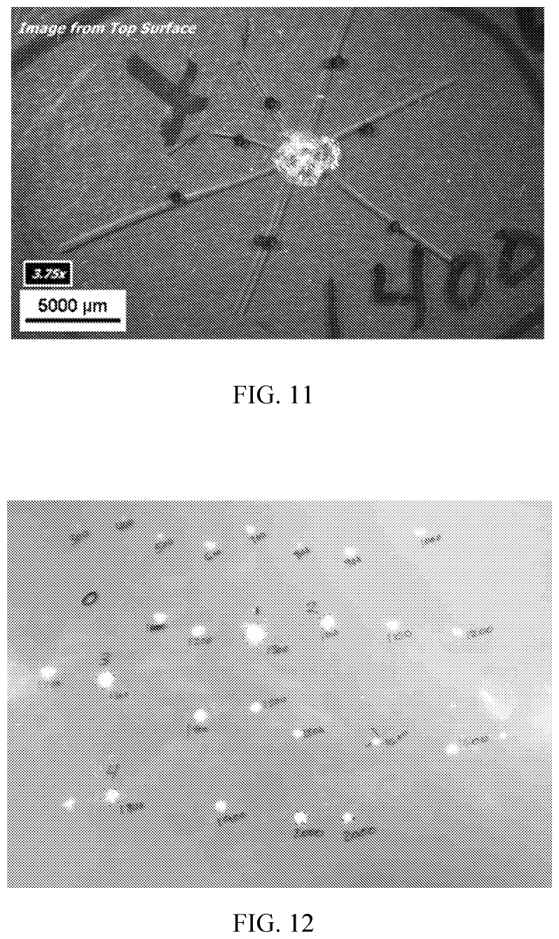

Though the failure height of Comparative Example 3 is slightly lower than that of Comparative Example 2, the size of the damage on Comparative Example 3 is smaller and may be considered a better result than that of Comparative Example 2. FIG. 10A and FIG. 10B show microscopic views of a top surface (FIG. 10A) and a back surface (FIG. 10B) of one sharp impact event on Comparative Example 3 from the results shown in FIG. 9. As shown in FIG. 10A and FIG. 10B, that damage is localized around the impact point and remains small even for high energy impacts.

However, the damage illustrated in FIGS. 9, 10A, and 10B may still penetrate the inner glass substrate. Due to such penetration, glass substrates configured according to Comparative Example 3 may exhibit delayed cracking after the initial impact. FIG. 11 shows a microscopic view of one sharp impact event on Comparative Example 3 from the results shown in FIG. 9 to illustrate delayed growth of cracks over time. As shown in FIG. 11, the small dots that cross the radial cracks indicate the extent of the radial cracks immediately after the sharp impact event. The extension of those radial cracks beyond the small dots illustrate the delayed extension/growth of the radial cracks over time.

FIG. 12 is a digital image showing results of sharp impact testing performed on Example 1. The failure height of Example 1, as shown in FIG. 12, is 2000 mm—a nearly two-fold increase over the failure heights achieved by the other examples subjected to the sharp impact testing. Moreover, Example 1 did not exhibit any delayed extension/grown of radial cracks over time.

While the disclosure has been illustrated and described in detail in the drawings and foregoing description, the same should be considered as illustrative and not restrictive in character. It is understood that only the preferred embodiments have been presented and that all changes, modifications, and further applications that come within the spirit of the disclosure are desired to be protected.

1. An article, comprising:
a glass laminate comprising a first glass clad layer, a second glass clad layer, and a glass core layer disposed between the first glass clad layer and the second glass clad layer, each of the first glass clad layer and the second glass clad layer fused to the glass core layer; and
a first composite layer attached to the glass laminate via a first polymer layer, the first composite layer comprising the first polymer layer and a first glass-based layer attached to the first polymer layer, the first glass-based layer comprising a compressive stress.

2. The article of claim 1, wherein the glass laminate has a thickness t_{GL}, the first glass-based layer has a thickness t_{G1}, and the first polymer layer has a thickness t_{P1}, and wherein t_{P1}<t_{G1}<t_{GL}.

3. The article of claim 2, wherein t_{P1}<10 μm.

4. (canceled)

5. The article of claim 2, wherein t_{G1}≤300 μm.

6. (canceled)

7. The article of claim 2, wherein t_{GL}≥1.0 mm.

8. (canceled)

9. The article of claim 2, wherein t_{GL}≤3.8 mm.

10. The article of claim 1, wherein:
the glass laminate has an effective coefficient of thermal expansion CTE_{GL},
the first glass-based layer has a coefficient of thermal expansion CTE_{G1},
the first polymer layer has a coefficient of thermal expansion CTE_{P1}, and
the compressive stress in the first glass-based layer comprises one or more additive portions of the compressive stress that arises from one or more relationships comprising two or more of CTE_{GL}, CTE_{G1}, and CTE_{P1}.

11. The article of claim 10, wherein a first additive portion of the compressive stress arises from a relationship among CTE_{GL}, CTE_{G1}, and CTE_{P1}.

12. The article of claim 11, wherein the relationship comprises CTE_{P1}−(CTE_{G1}+CTE_{GL})/2>1 ppm/° C.

13. The article of claim 10, wherein a second additive portion of the compressive stress arises from a differential between CTE_{GL} and CTE_{G1}.

14. The article of claim 13, wherein |CTE_{GL}−CTE_{G1}≥0.4 ppm/° C.

15. (canceled)

16. The article of claim 1, wherein the compressive stress in the first glass-based layer is in a range from about 5 MPa to about 100 MPa.

17. The article of claim 1, wherein the first polymer layer has a glass transition temperature of greater than or equal to 20° C.

18. The article of claim 1, wherein the first polymer layer has a storage modulus greater than or equal to 5 MPa and less than or equal to 20,000 MPa at temperatures between 0° C. and 40° C.

19. The article of claim 1, wherein the glass core layer has a coefficient of thermal expansion CTE_{core}, and wherein the first glass clad layer and the second glass clad layer each have a coefficient of thermal expansion CTE_{clad} that is less than the CTE_{core}.

20. The article of claim 1, wherein a maximum tensile stress in the glass core layer is less than about 10 MPa.

21. The article of claim 1, wherein the first glass clad layer and the second glass clad layer each have a clad compressive stress and the clad compressive stress extends from a surface of the first clad layer and the second glass clad layer, respectively, to a depth of compression of greater than or equal to 10% of a thickness of the glass laminate tGL.

22-27. (canceled)

28. The article of claim 1, further comprising a second composite layer attached via a second polymer layer to the glass laminate or the first composite layer, the second composite layer comprising the second polymer layer and a second glass-based layer attached to the second polymer layer, wherein the second glass-based layer has a thickness t_{G2} and a coefficient of thermal expansion CTE_{G2}, and wherein the second polymer layer has a thickness t_{P2} and a coefficient of thermal expansion CTE_{P2}.

29. The article of claim 28, wherein the second composite layer is attached to the glass laminate.

30-34. (canceled)

35. A sensor, comprising:
an enclosure;
a detection element disposed in the enclosure; and
a window attached to the enclosure to enclose an interior of the enclosure, the window comprising the article of claim 1.

36-43. (canceled)
